(19) United States
(12) Patent Application Publication
(10) Pub. No.: US 2004/0094971 A1
(43) Pub. Date: May 20, 2004

(54) Lock with a latch held in a closed position by a detent pawl

(76) Inventors: Werner Warmke, Muhlheim (DE); Bernd Kluting, Radevormwald (DE); Frank Horschgen, Solingen (DE)

Correspondence Address: Martin A Farber, Suite 473, 866 United Nations Plaza, New York, NY, 10017, US

(21) Appl. No.: 10/433,864

(22) PCT Filed: Dec. 6, 2001
(86) PCT No.: PCT/EP01/14344

(30) Foreign Application Priority Data
Dec. 7, 2000 (DE) 100 60 778.0
Jul. 2, 2001 (DE) 101 31 965.7

(51) Int. Cl. E05C 3/06

(52) U.S. Cl. 292/201

(57) ABSTRACT

The invention relates to a lock with a latch (32), held in the closed position by means of a detent pawl (36). A tripping device (39) co-operates with the detent pawl (36) and with a safety element (43, 51, 54), which can adopt a working position, permitting a displacement of the detent pawl (36), by a tripping action and a safety position, permitting an idle operation of the tripping device on operation thereof, whereby on switching between the working and the safety position, with a tripping device (39) in the release position thereof, the detent pawl (36) is moved to the released position thereof. The pivot bearing (S) for the tripping device is non-active in the safety position in order to improve the force transmission and the control.

The invention relates to a lock having a latch which can be displaced between an open position and a closed position and is retained in the closed position by a catch, it being possible for the catch, by virtue of a release means being pivoted about a pivot bearing, to be moved from a blocking position into a release position which allows the latch to be displaced into its open position, the release means acting on the catch, and having a safety member which can assume an active position, which allows displacement of the catch by release means actuation, and a safety position, which allows the release means to be inoperative upon actuation, the changeover between the active position and the safety position of the safety member taking place, in particular, by an electric motor such that with the release means moved into the release position, upon changeover from the safety position into the active position, the catch is moved into its release position.

A lock of the type in question is known from WO 00/20710 A, the pivot point of the release means being the catch spindle. Additionally seated on the catch spindle is a catch-disengagement lever which, together with the triggering lever, forms a funnel-shaped opening which, for its part, interacts with a safety member carried by a safety lever. The safety lever, for its part, can be driven. Displacement of the safety lever is thus accompanied by the safety member being moved into a safety position or into an active position. By virtue of this configuration, with the triggering lever initially displaced, in the locked position of the lock, it is then possible for the safety member to be displaced, in which case the catch is also released.

It is an object of the invention to develop a lock of the generic type in respect of force transmission and control.

This object is achieved first and foremost in the case of a lock having the features of claim 1, this being based on the fact that a safety lever which carries the safety member is driven for pivoting action by a helical drive rib which penetrates into an engagement opening and is disposed on a shaft. This configuration makes it possible to achieve a high level of force transmission by way of a drive with relatively small dimensions. Along with a rotary displacement of the shaft, via the helical drive rib of the latter, the safety lever is displaced. During the displacement of the latter, the engagement is not relinquished. The safety lever is thus positively controlled. This helical drive rib, rather than extending over the entire circumferential length of the shaft, leaves free an axially extending gap, in which the safety lever can move freely. This free movement capability of the safety lever is done away with when the helical drive rib is located in the engagement opening. The drive rib has two end surfaces. As soon as one end of the drive rib moves out of the engagement opening, the other end surface of the drive rib strikes against the broad side surface of the safety lever and causes the motor-driven shaft to be stopped. The shaft also drives the safety lever with self-stopping action in the opposite direction.

The object of the invention is also achieved by the fact that the pivot bearing of the release means has no function in the safety position. If the safety member assumes its active position, then, by virtue of the release means being displaced, the catch can be moved into its release position in relation to the latch. The lock is thus unlocked and the motor-vehicle door can therefore be opened. A defined pivot bearing of the release means is then present. If, however, the safety member is moved, as a result of changeover, into the safety position, then this pivot bearing has no function. It then thus does not perform any task as a pivot point for the release means. The release means then pivots about another point of rotation, although this does not cause the catch to be released into the release position. In detail, the procedure here according to the invention is such that the release means is made to float by changeover into the safety position. The defined pivot bearing is not present in the safety position. The floating displacement of the release means then does not cause the catch to be released. According to the invention, it is provided that the safety member, in the active position, performs an abutment function, which is done away with in the safety position. The pivot bearing, accordingly, is formed by abutment of the release means against the safety member. This is the active position, in which the safety member forms the abutment function. If the safety member leaves its active position, the safety position is thus present. A variant is distinguished in that the release means has a cam on which, with the release means actuated, the safety member acts as it is advanced into the active position and there, sliding along into the abutment position, transfers the catch into the open position. This means that with displacement of the release means by exterior-handle actuation, without obstruction via the cam, the safety member can pass into the abutment position, the catch being moved into its release position at the same time. Predetermined floating of the release means results from the fact that the arm of the release means which acts on the catch or the pivot bearing of the release means is guided in an arcuate manner. This is straightforwardly achieved in that the arcuate guide is formed by a slot/pin guide. Drive-related advantages are achieved by the safety member being in the form of a pivoting lever. With the inclusion of a bearing link plate, the safety member acts on the bearing link plate of the release means, the cam being assigned to the bearing link plate. Here too, it is the case, once again, that, with the safety member moved into the safety position, the pivot bearing of the release means has no function and displacement of the latter does not result in the catch being released in relation to the latch. A further realization of the idea of the invention consists in that the displacement plane of the safety member is located perpendicularly to the displacement plane of the release means. The safety member may then be actuated, for example, electromagnetically or hydraulically or pneumatically. If the safety member assumes its safety position, then the release means does not have any abutment. This means that its pivot bearing has no function and actuation of the release means does not give rise to the release position of the catch. If the safety slide, which can be displaced in the axial direction of the pivot bearing and constitutes the safety member, assumes its active position, it moves into an arresting opening of a housing base plate. This means that it is supported, so that it is able, while performing its abutment function, to absorb considerable forces.

The object of the invention is further achieved, in the case of a lock of the generic type, in that the safety member is a piston member a drive shoulder of the release means can be displaced in the active direction into a coupling position in relation to a mating shoulder of the catch. By virtue of this piston member, the drive shoulder of the release means can be moved into a coupling position in relation to the mating shoulder of the catch or into an uncoupled position. If the coupling position is present, then release means actuation causes the catch to be displaced into the release position. It is thus then possible for the lock to be opened. If, in contrast, the uncoupled position is present, the release means is inoperative. The safety position is thus present. The piston member here is the push rod of a linear drive. For example, the push rod may be the movable armature of an electromagnet. A pneumatic or hydraulic drive is also conceivable. The linear drive may be associated with the lock housing. It is also possible, however, for the piston member to be disposed on the release means. This means that the linear drive is secured on the release means and the piston member can be moved back and forth. If, in contrast, the linear drive is associated in a fixed manner with the lock housing, displacement of the piston member gives rise to a longitudinal displacement of the release means. In order to achieve the object of the invention, it is then also possible to provide a configuration in which the pivot bearing of the release means is associated with the safety member and, by virtue of the displacement of the latter, the release means can be moved from the inoperative position into the active position. A high level of functional reliability is also present in the case of this version. In detail, it is provided here that the pivot bearing is seated on a lever arm of the safety member. With the release means already displaced in the safety position into its release position, the safety member then causes the catch to pivot, with sloping-flank drive, into the release position in relation to the rotary latch, so that the lock can be opened.

A further version by means of which the object of the invention is achieved consists in that the pivot bearing can be displaced back and forth between active position and safety position. The respective operative position changes in conjunction with a displacement of the pivot bearing. In this way, the active position or safety position can be realized just by changing the position of the pivot bearing. This can preferably be achieved in that the safety member is a carrier for the pivot bearing of the release means. Corresponding displacement of the safety member, accordingly, can move the pivot bearing into either the active position or safety position. According to the invention, it proves to be advantageous here for the pivot bearing to be guided in a link guide of the lock housing. Positive guidance, which ensures a high level of operational reliability of the lock, is thus provided. Defined positions of the safety member result from the fact that the safety member is a pivoting body, in particular pivoting lever, which can be displaced between two fixed stops. This measure also results in a straightforward, cost-saving construction of the lock itself. In order that the pivoting lever or the safety member remains as intended in the respective end position, the release means, which is articulated at the free end of the pivoting lever, is a two-armed angle lever, the short, load arm of which engages beneath the catch and the long, force arm of which is directionally activated for the purpose of releasing the catch such that the pivoting lever is forced against the fixed stop associated with the respective position. A further advantageous feature consists in that, in the safety position, the obtuse angle enclosed by the pivoting lever and by the force arm of the non-actuated release means opens in the opposite direction to that in the active position. In order to achieve optimum functional reliability, the invention further proposes that the pivoting lever or the safety member is retained in its respective pivoting end position by means of an over-dead-center spring. Finally, a configuration according to the invention is also distinguished in that the safety member is connected to the housing by a toggle lever, which toggle lever assumes a secured over-dead-center position in the active position. By means of the toggle lever, the safety member can be displaced such that the pivot bearing of the release means can be displaced back and forth between the active position and the safety position.

A number of exemplary embodiments of the invention are explained hereinbelow with reference to accompanying drawings, in which:

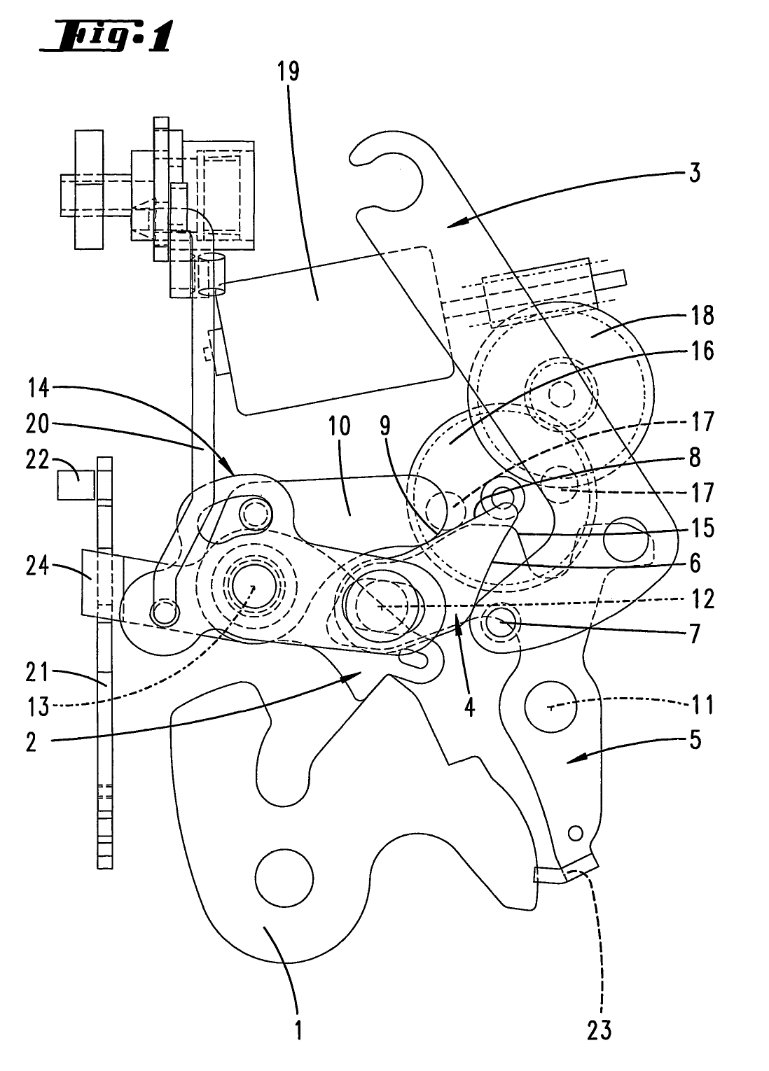

FIG. 1 shows the significant elements of a lock according to the first embodiment in the unlocked state, with the release means not actuated,

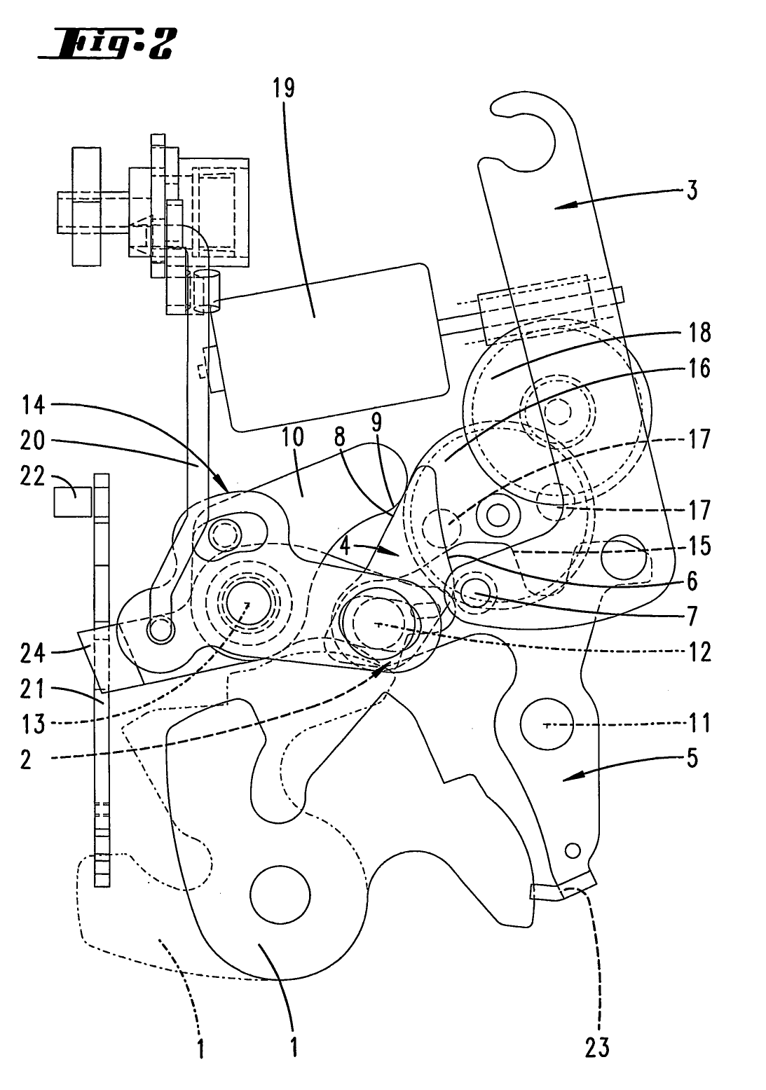

FIG. 2 shows a follow-up illustration to the position illustrated in FIG. 1, with the release means moved into the active position,

FIG. 3 shows the lock in the blocking position with the safety lever displaced into the safety position,

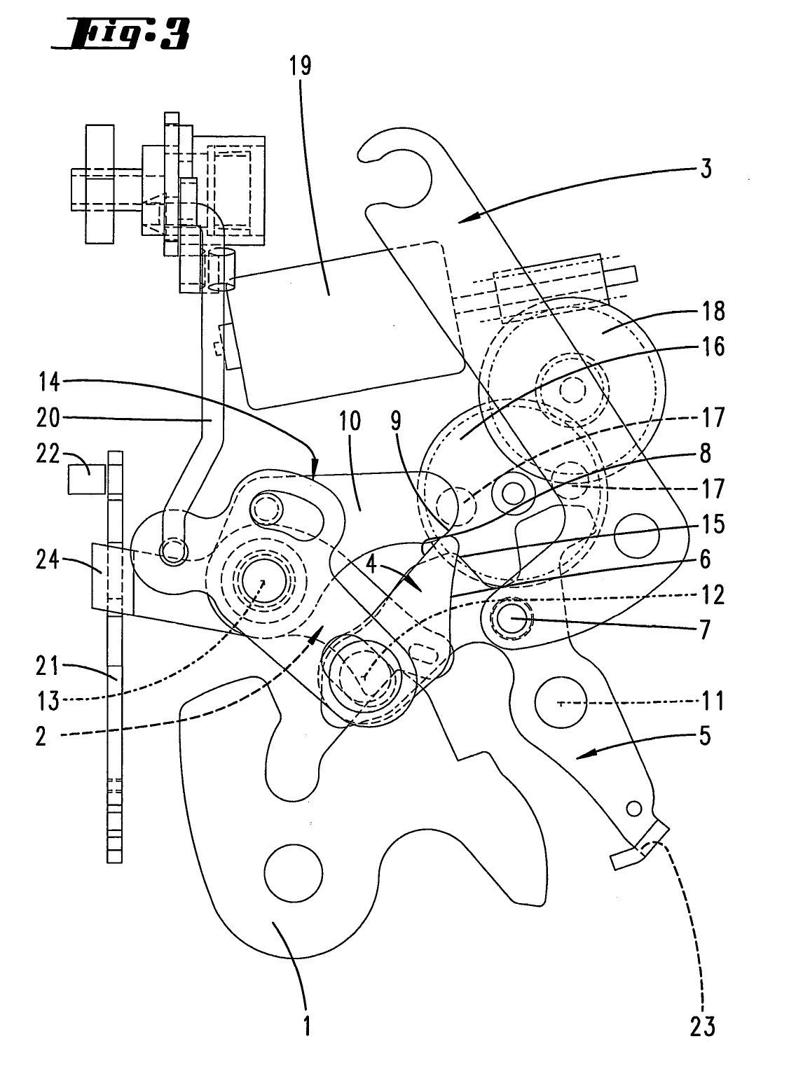

FIG. 4 shows the lock in the blocking position with the release means moved into the active position,

FIG. 5 shows a second exemplary embodiment of the invention,

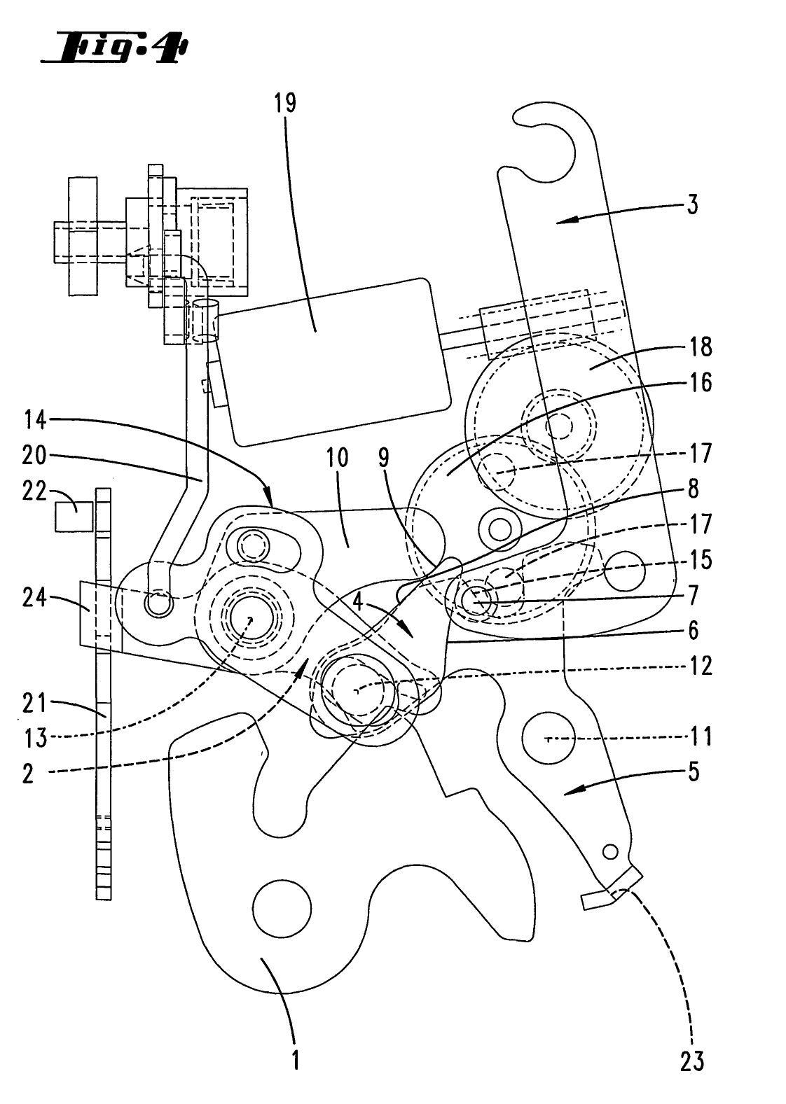

FIG. 6 shows the illustration of the safety-lever drive according to the second exemplary embodiment in the first functional position,

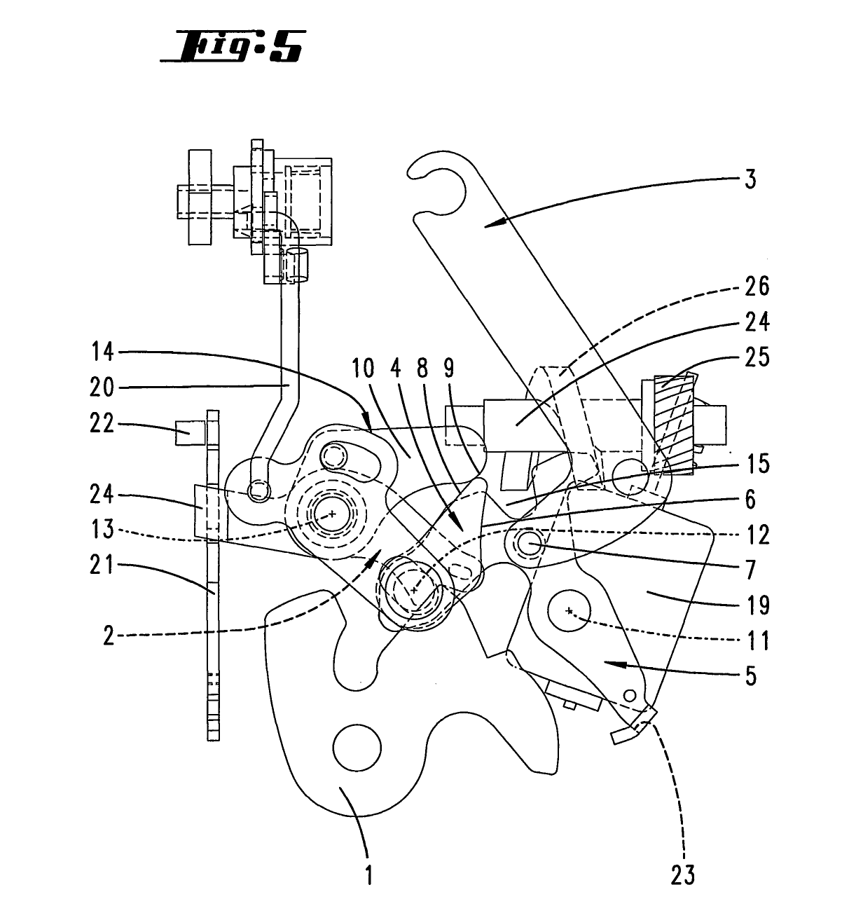

FIG. 7 shows an illustration according to FIG. 6 in a second functional position,

FIG. 8 shows an axial plan view of the shaft carrying the helical drive rib,

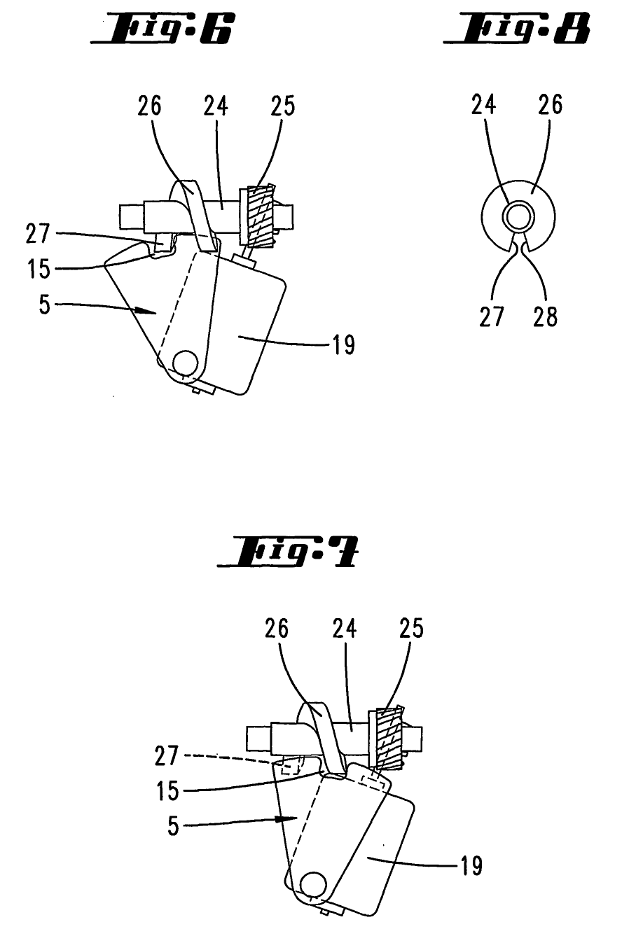

FIG. 9 shows a view of the lock according to the third exemplary embodiment, the safety member assuming its active position and the release means not having been actuated,

FIG. 10 shows the follow-up illustration to FIG. 9, with release means actuated and catch moved into release position,

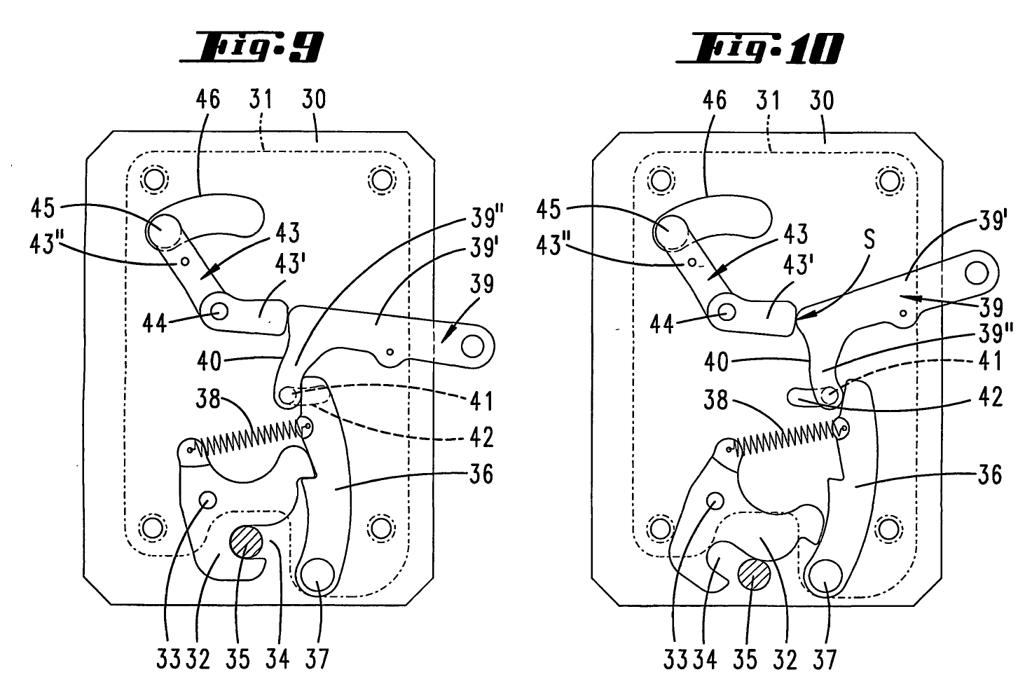

FIG. 11 shows the lock in the position in which the safety member has been moved into its safety position,

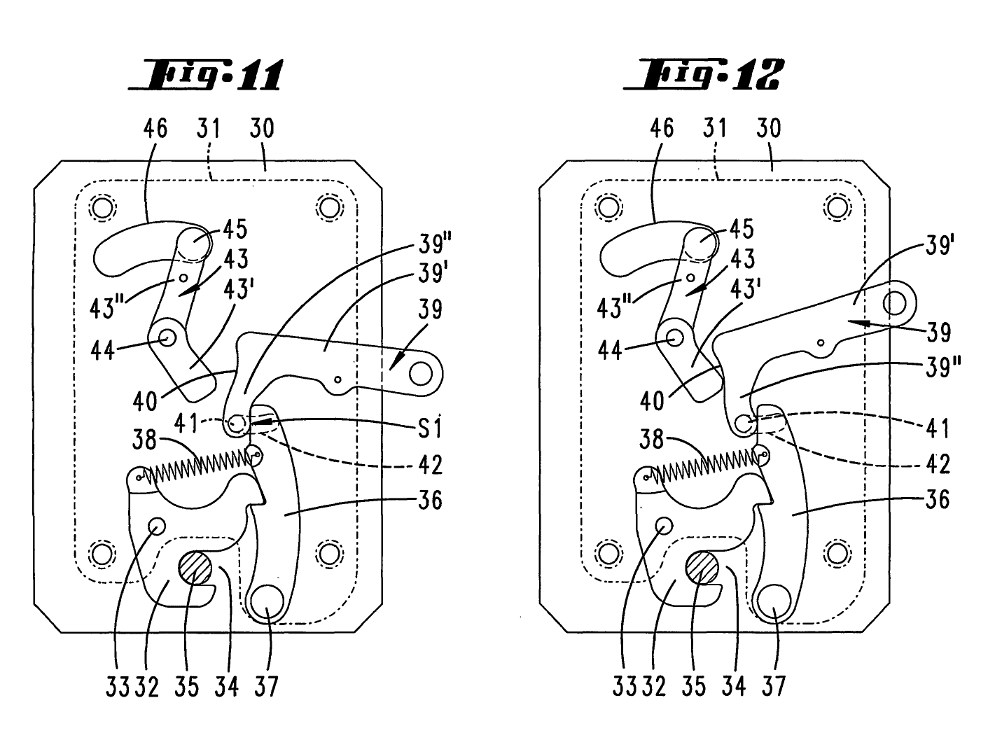

FIG. 12 shows the follow-up illustration to FIG. 11, to be precise with the release means actuated, without releasing the catch in the process.

FIG. 13 shows the lock in the position in which the release means has been actuated and the safety member pivots into the active position along with the catch being released,

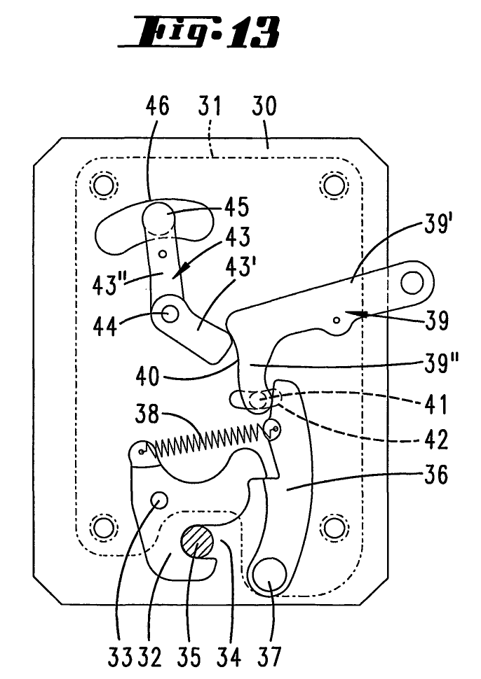

FIG. 14 shows a view of the lock according to the fourth exemplary embodiment, the safety member assuming its active position and the release means not having been actuated,

FIG. 15 shows the follow-up illustration to FIG. 14, to be precise with release means actuated and catch transferred into release position,

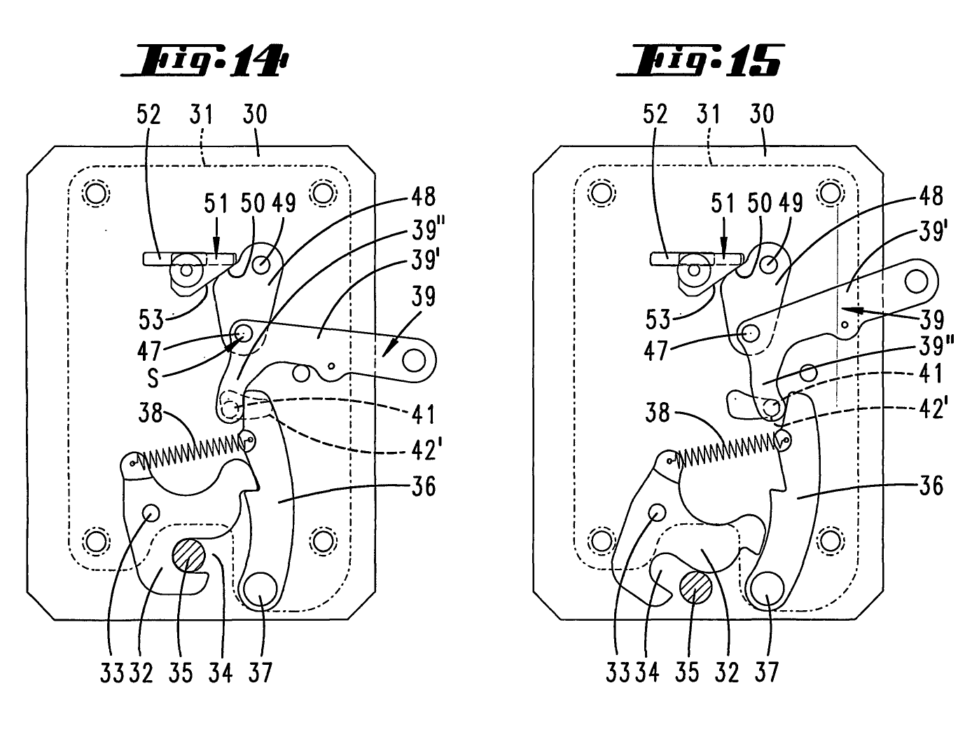

FIG. 16 shows the lock with the safety member assuming the safety position and the release means not actuated,

FIG. 17 shows an illustration which is comparable to FIG. 16, the release means having been actuated without displacing the catch,

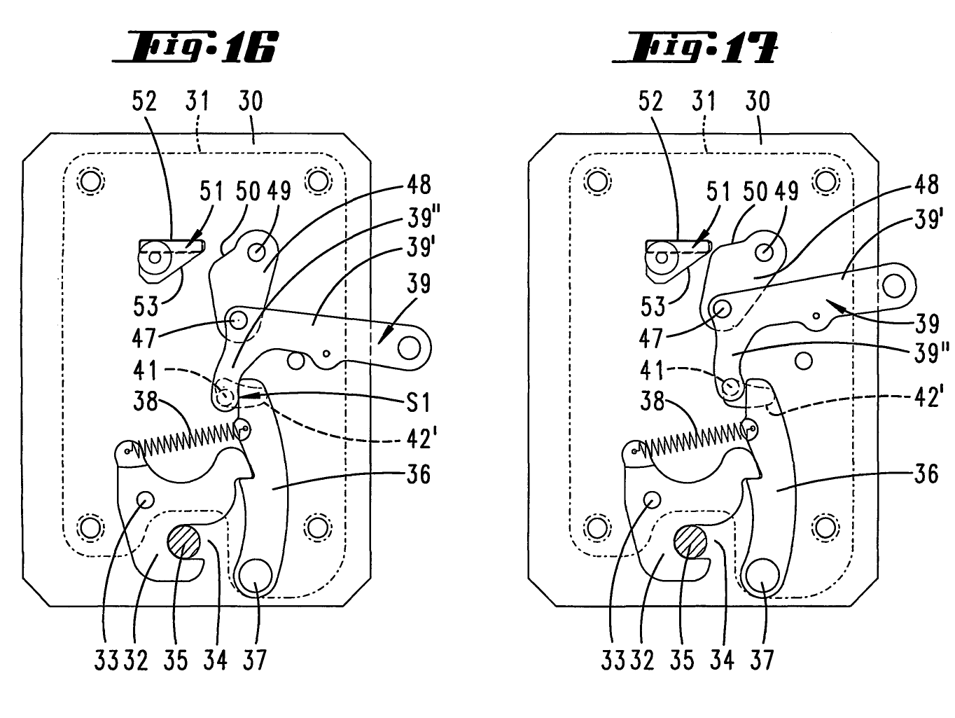

FIG. 18 shows the lock with release means actuated and safety member moving into the active position, along with the catch being displaced into its release position in relation to the latch,

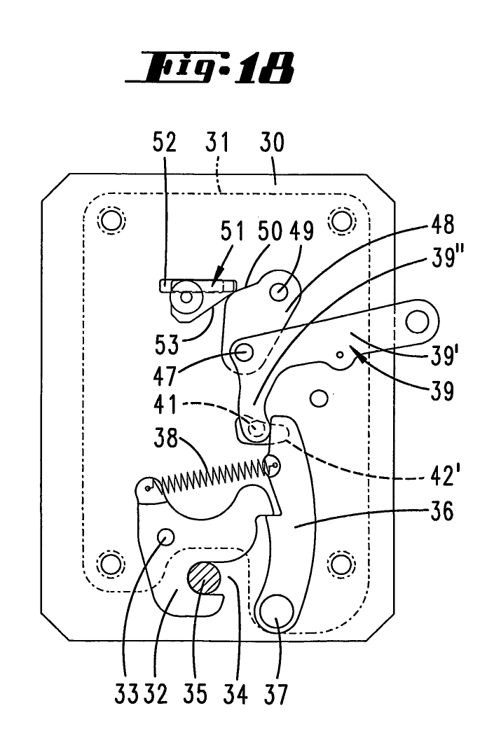

FIG. 19 shows a view of the lock according to the fifth exemplary embodiment, the unlocked state prevailing and the release means not having been actuated, that is to say the safety member assuming its active position,

FIG. 20 shows the section along line XX-XX in FIG. 19,

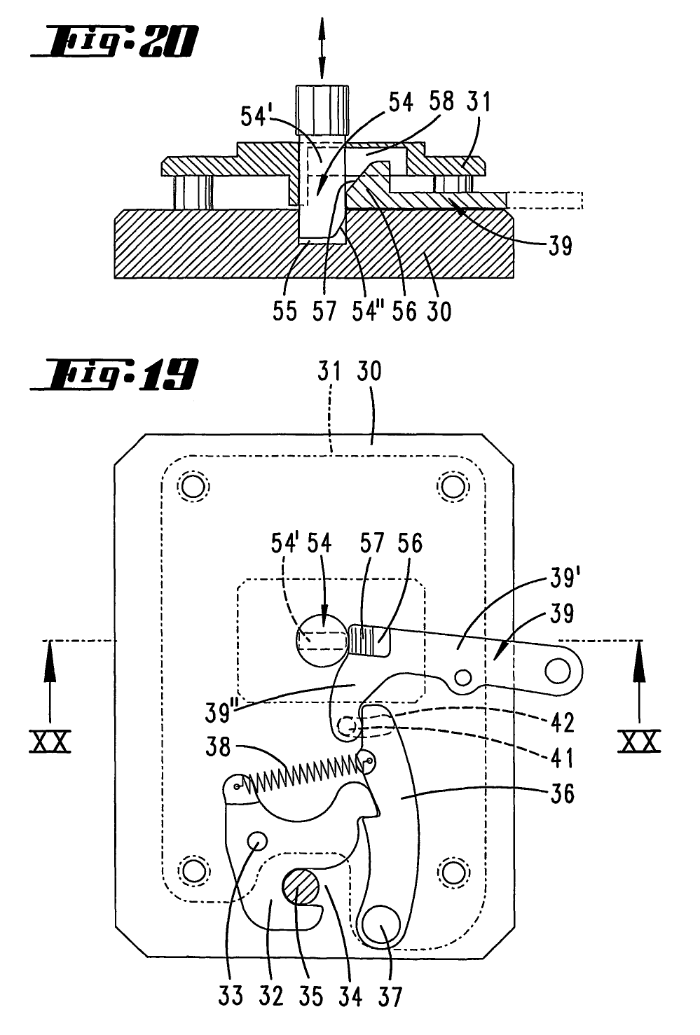

FIG. 21 shows the follow-up illustration to FIG. 19, to be precise, in contrast to the latter, with the release means actuated and the catch released,

FIG. 22 shows the section along line XXII-XXII in FIG. 21,

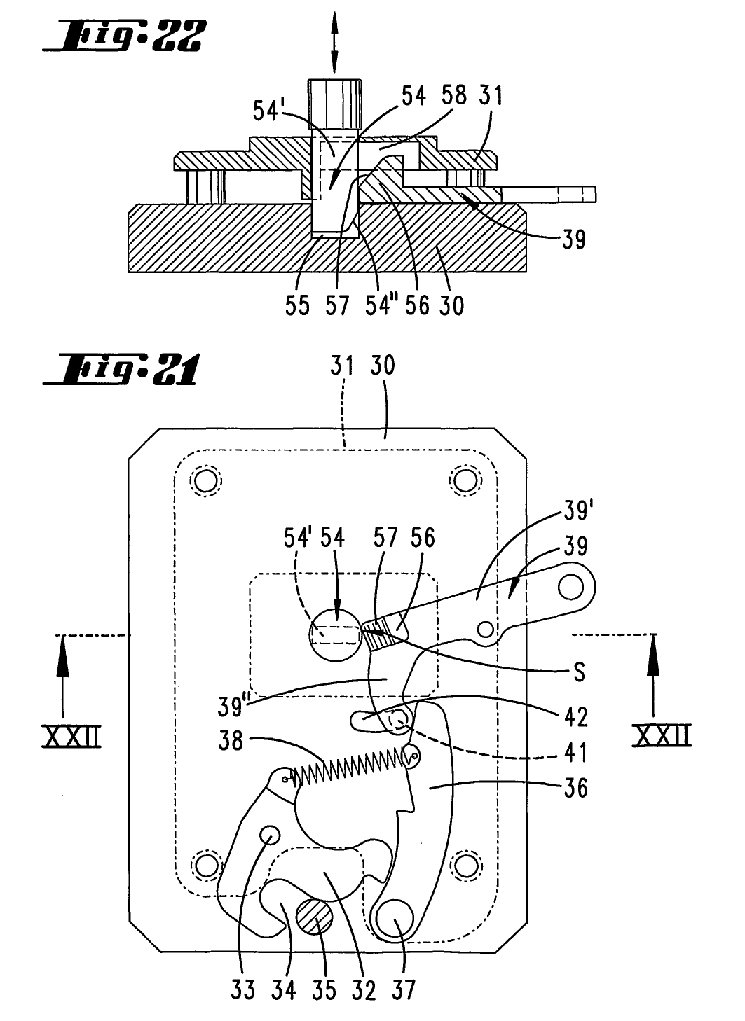

FIG. 23 shows the lock with the safety member assuming its safety position, to be precise with the release means not actuated,

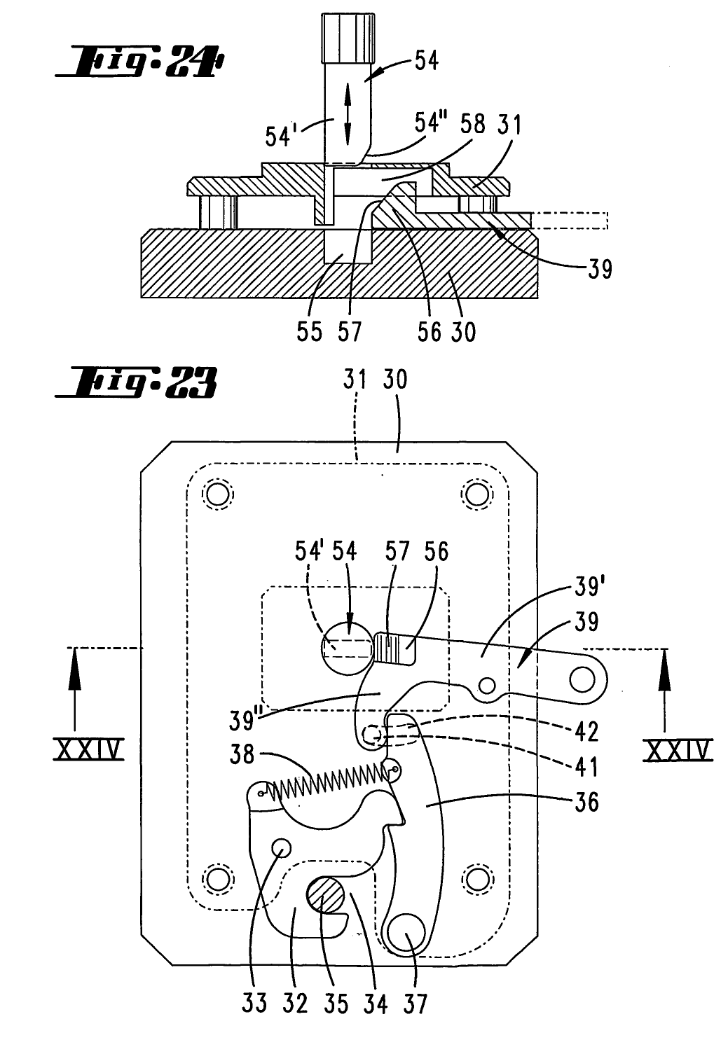

FIG. 24 shows the section along line XXIV-XXIV in FIG. 23,

FIG. 25 shows the lock in the position in which the safety member has moved into its safety position and the release means has been actuated, without disengaging the catch in the process,

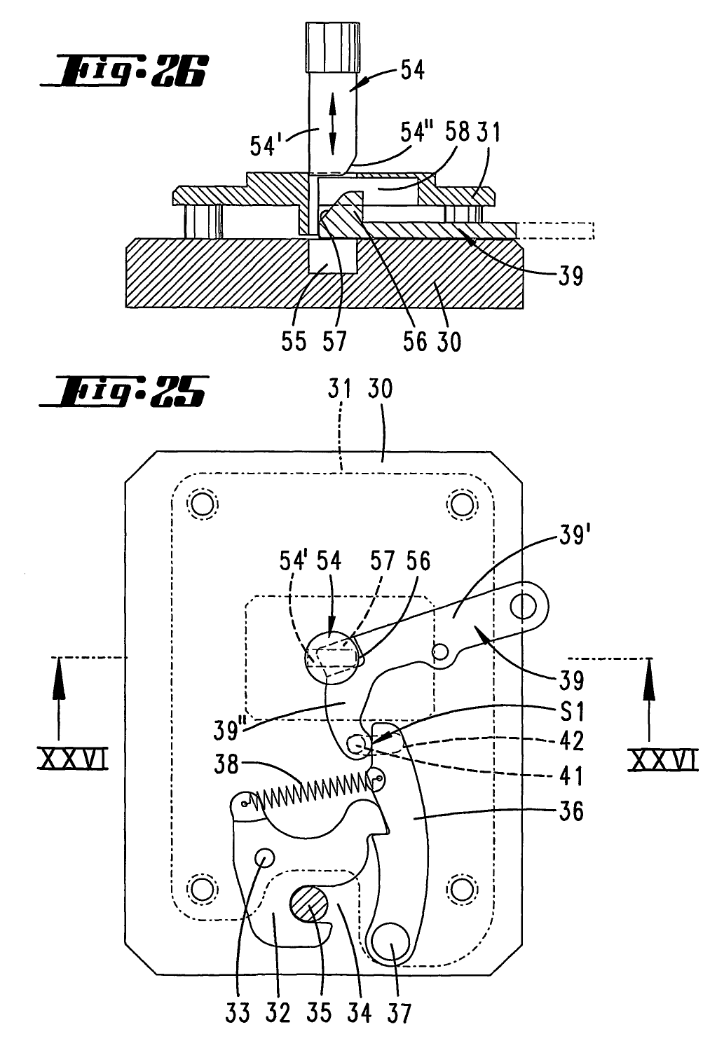

FIG. 26 shows the section along line XXVI-XXVI in FIG. 25,

FIG. 27 shows the lock with the release means actuated and with the safety slide being displaced from the safety position into the active position,

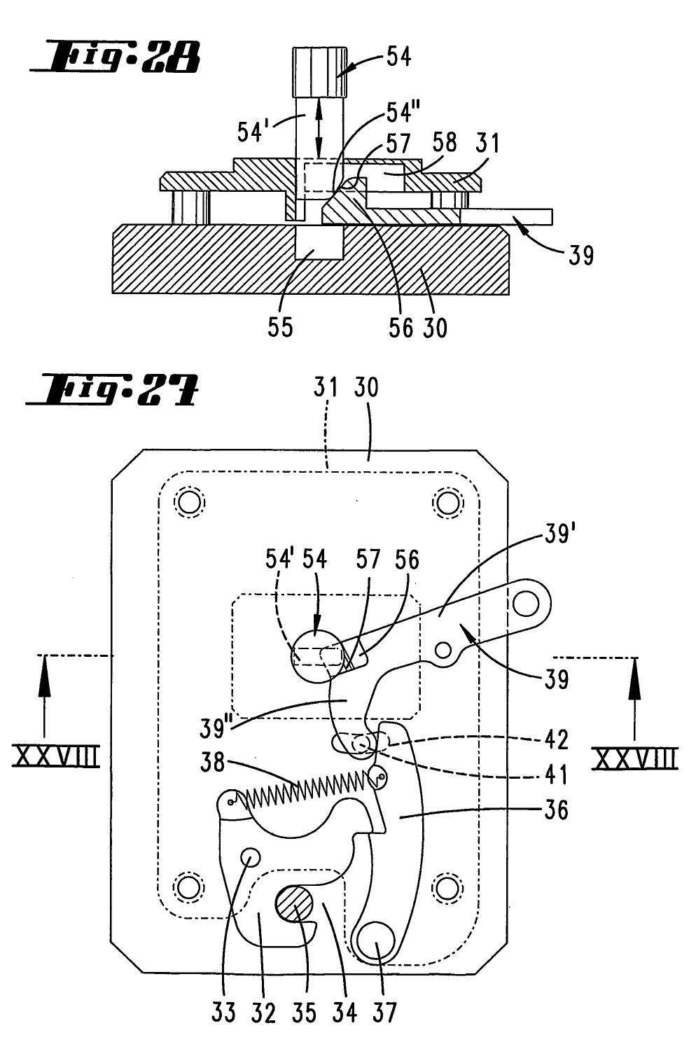

FIG. 28 shows the section along line XXVIII-XXVIII in FIG. 27,

FIG. 29 shows the significant components of the lock according to the sixth embodiment in the unlocked position and with the release means not actuated,

FIG. 30 shows an illustration like FIG. 29, but with the release means actuated and the catch moved into the release position,

FIG. 31 shows the lock in its safety position and with the release means not actuated,

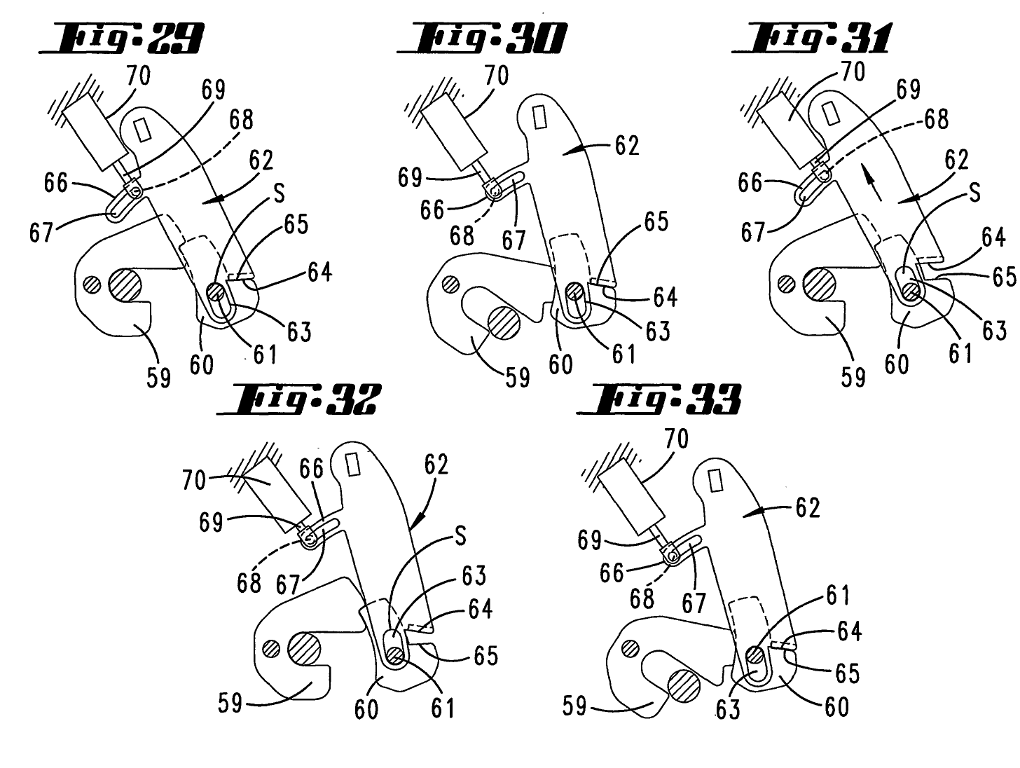

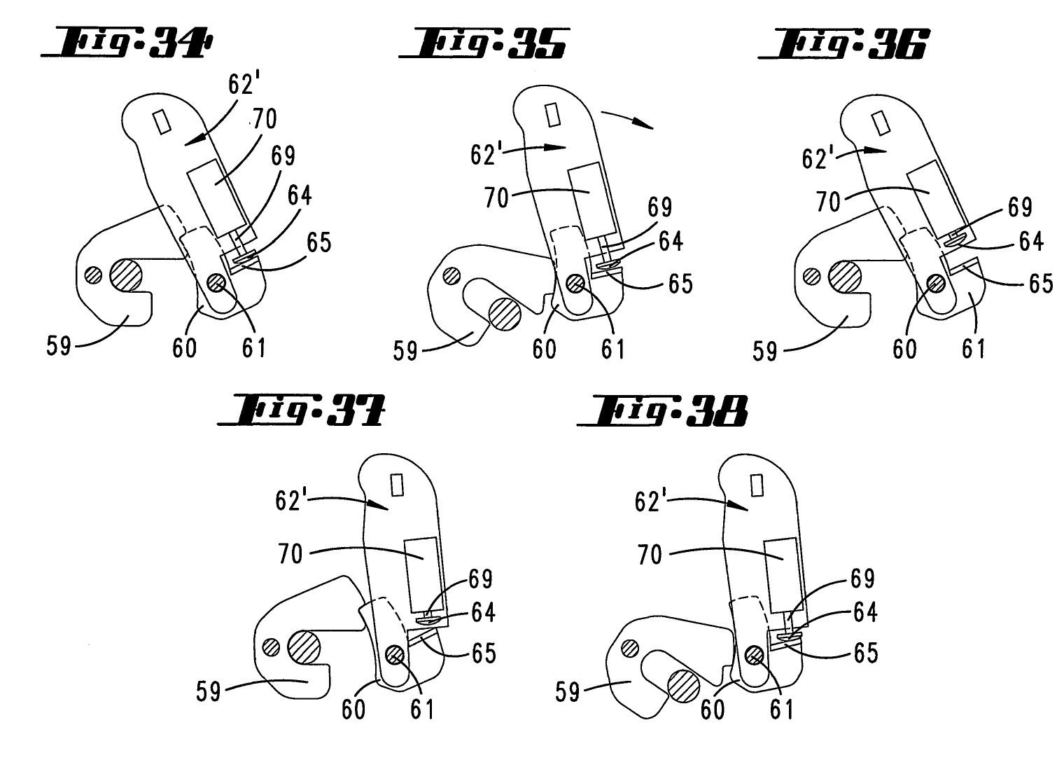

FIG. 32 shows an illustration like FIG. 31, the release means having been pivoted into its release position,

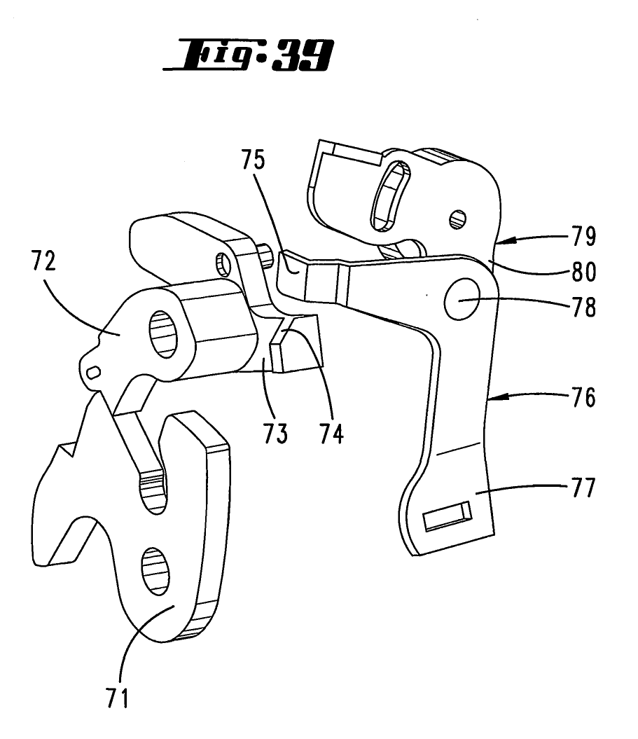

FIG. 33 shows the follow-up illustration to FIG. 32, the release means, which assumes its release position, having been displaced longitudinally by the safety member, with the catch being pivoted in the process into the release position in relation to the rotary latch,

FIG. 34 shows the significant components of the lock according to the seventh embodiment in the unlocked position,

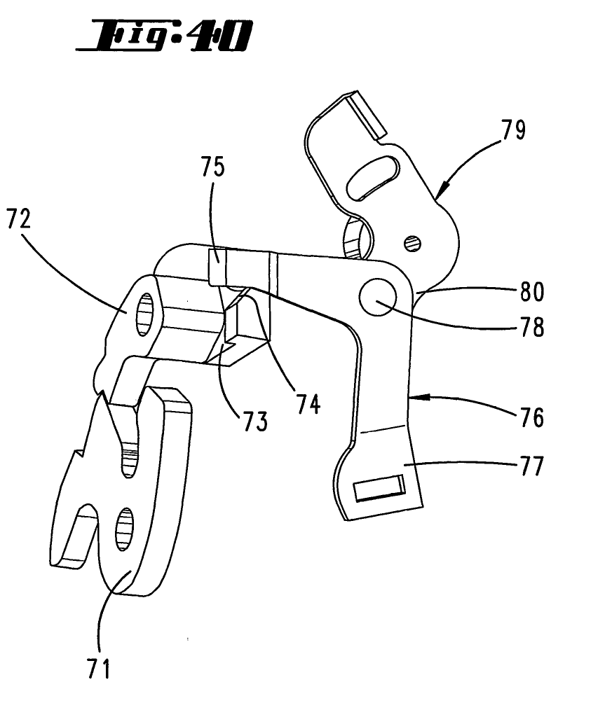

FIG. 35 shows the follow-up illustration to FIG. 34, to be precise with release means displaced into the release position,

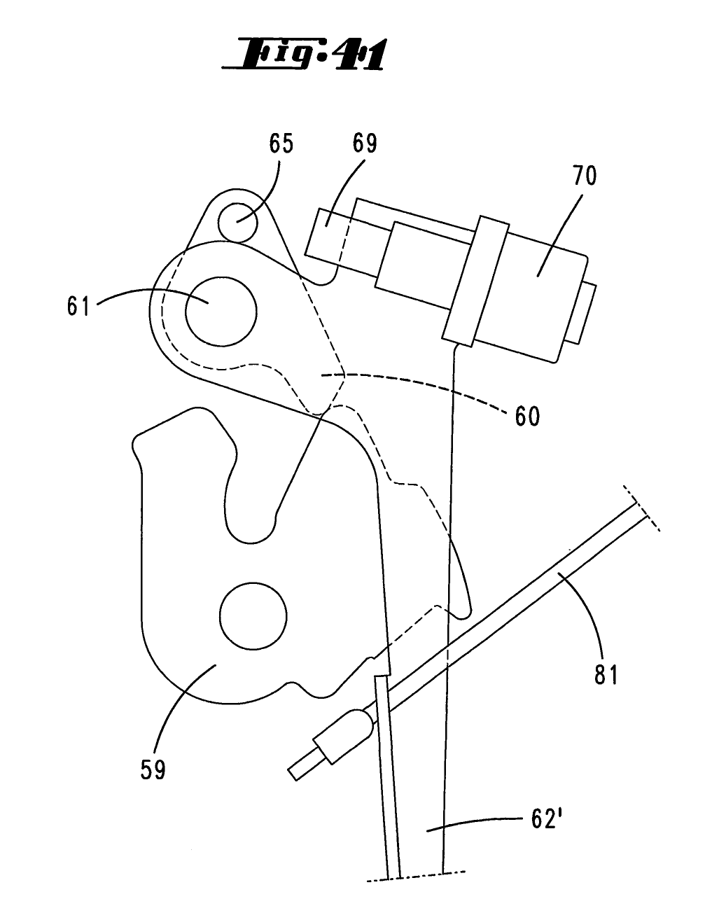

FIG. 36 shows the lock in the safety position, with release means not actuated,

FIG. 37 shows the follow-up illustration to FIG. 36, the release means having been actuated,

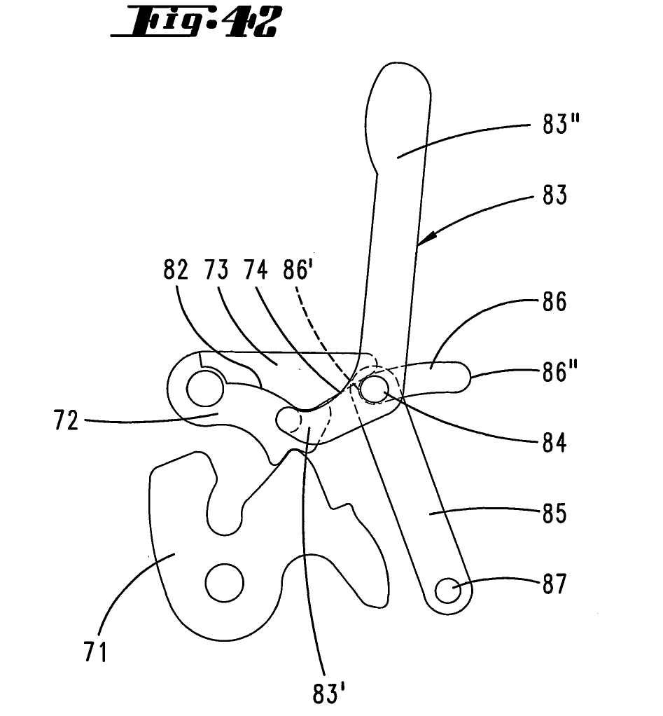

FIG. 38 shows the position of the lock with the release means actuated and the lifting push rod being displaced, with the catch being pivoted in the process into the release position,

FIG. 39 shows a perspective illustration of the lock components according to the eighth embodiment in the unlocked position, which allows release of the catch by means of the release means,

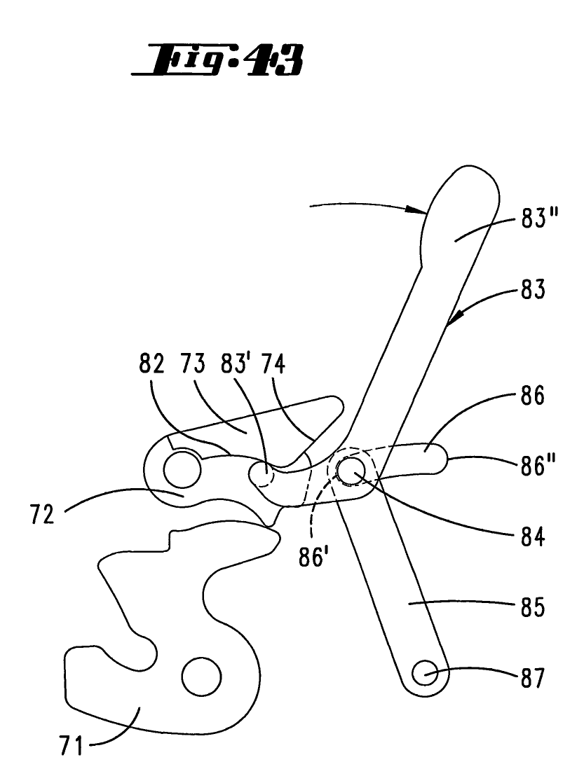

FIG. 40 shows an illustration which is comparable to FIG. 39, but relates to the safety position of the lock,

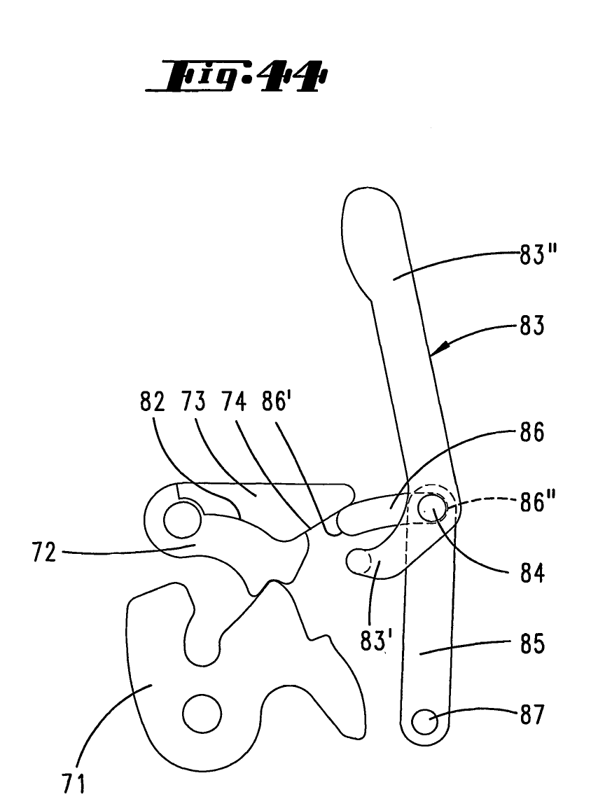

FIG. 41 shows the significant components of a lock according to the ninth embodiment in the safety position, with release means not actuated, which lock, in terms of construction, corresponds largely to the lock illustrated in FIGS. 34-38,

FIG. 42 shows the significant components of a lock according to the tenth embodiment, the lock being in the non-actuated, unlocked position,

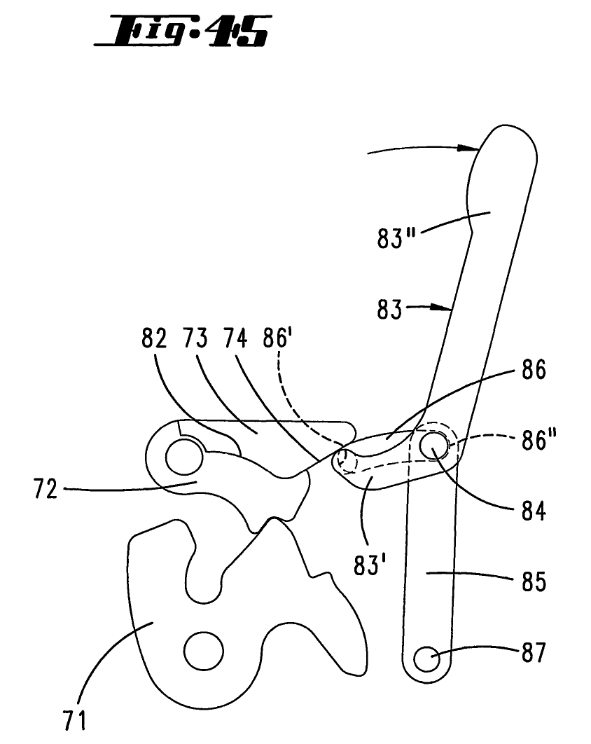

FIG. 43 shows the follow-up illustration to FIG. 42, but with release means actuated and catch thus disengaged,

FIG. 44 shows the lock in the safety position, with release means not actuated,

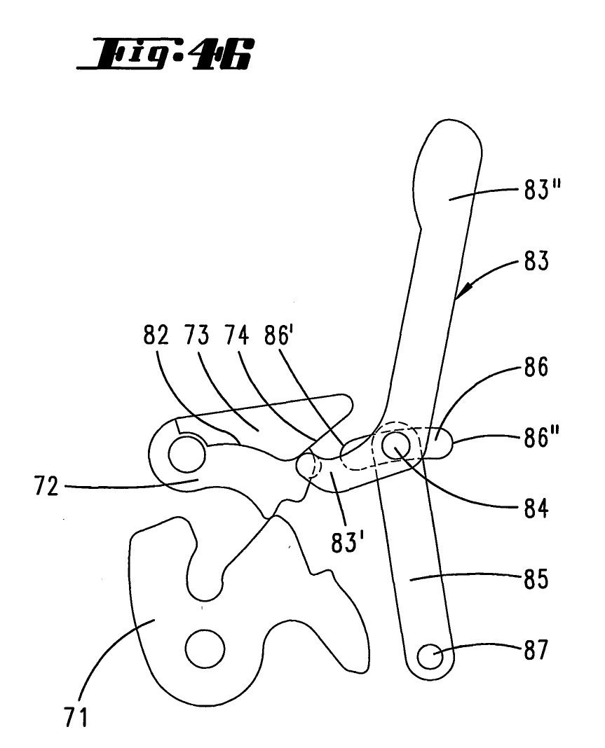

FIG. 45 shows the follow-up illustration to FIG. 44, to be precise with release means pivoted, without disengaging the catch in the process,

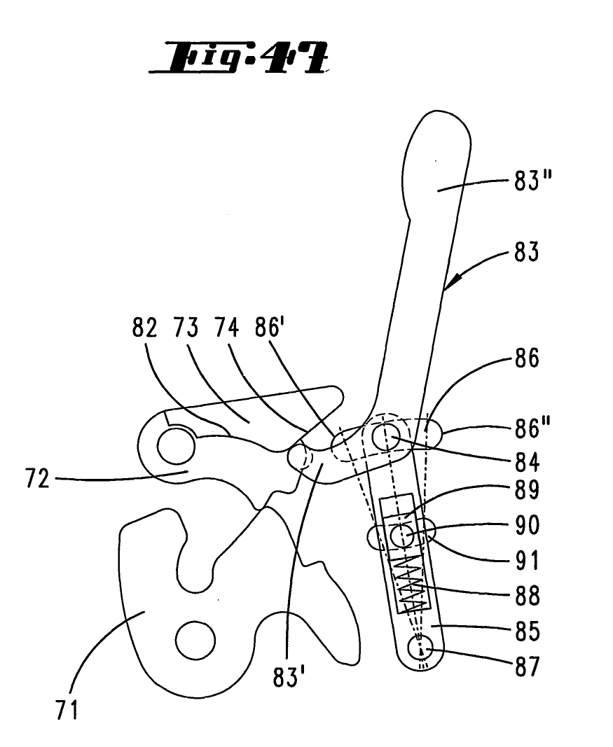

FIG. 46 shows the position of the lock with release means actuated and safety member being displaced out of the safety position for the purpose of disengaging the catch,

FIG. 47 shows an illustration, in detail representation, of the safety lever in its dead-center position,

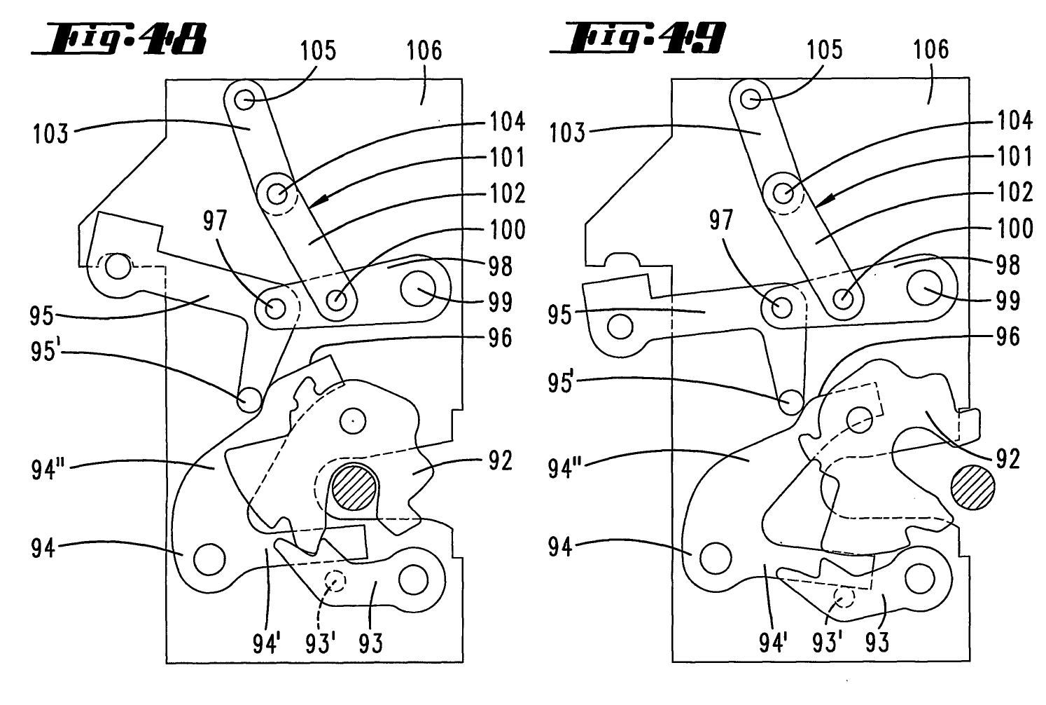

FIG. 48 shows a view of the lock according to the eleventh embodiment in the non-actuated, unlocked position,

FIG. 49 shows the follow-up illustration to FIG. 48, the release means having been actuated and the catch thus being transferred into the release position in relation to the rotary latch,

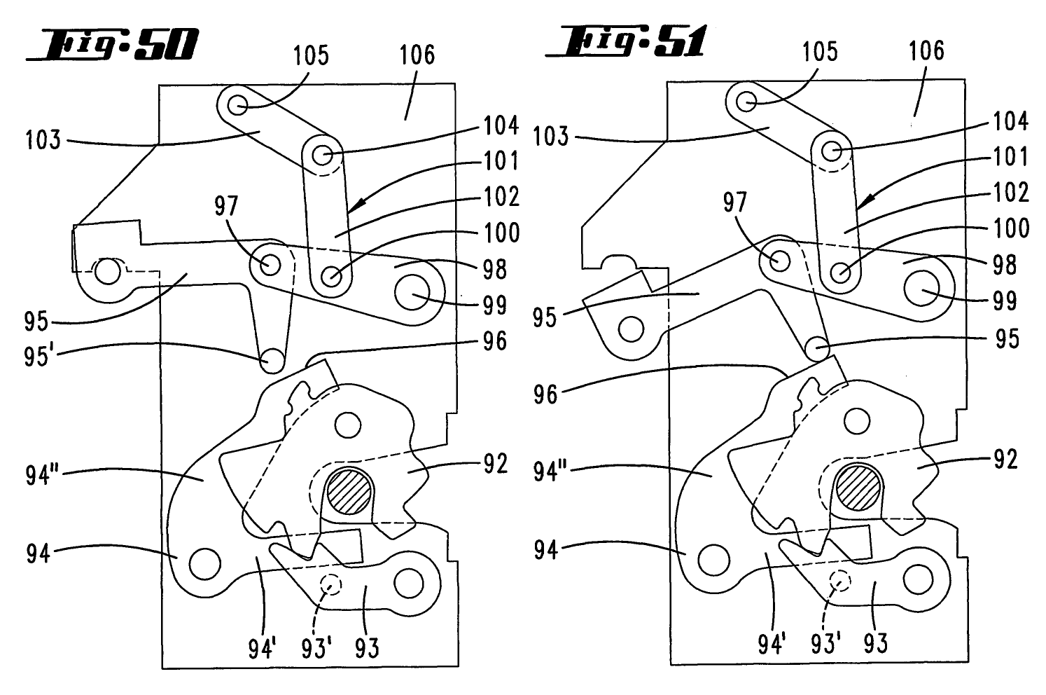

FIG. 50 shows the lock in the non-actuated locked position, and

FIG. 51 shows the lock in the actuated locked position.

For the sake of clarity, in FIGS. 1 to 4, which show the first exemplary embodiment, only those elements of a rotary-latch closure which are pertinent to the invention are illustrated.

The lock has a rotary latch 1 which can be displaced in known manner counter to spring force, about a housing-mounted spindle, from an open position into a closed position. In the closed position, the rotary latch 1 is retained by a catch 2. The catch 2 is likewise preloaded into its blocking position by means of a spring. By virtue of the catch 2 being pivoted (in the exemplary embodiment in the anti-clockwise direction), the catch 2 is displaced into its release position, in which the rotary latch 1 can assume its open position. The displacement of the catch 2 into the release position can take place by means of an interior handle 21 which, by way of a cam 22, acts upon a continuation 24 of the catch 2. The catch 2 then rotates about its point of rotation 13. With the actuation of the interior handle 21, a release lever 14 is displaced at the same time, this lever acting on a safety lever 5 in order to displace the latter into an active position. The release lever 14 can be pivoted here about the point of rotation 13 of the catch 2. It acts on a point of articulation 12 of a safety member 4, this point of articulation 12 being associated with the safety lever 5, which can be pivoted about a housing-mounted pivot spindle 11.

The safety lever 5 has, at its free end, a switching cam 23, which interacts with switches (not illustrated) in order to determine the operating position of the safety lever 5. The safety lever 5 can be displaced by an electric motor 19 from its active position into its safety position and vice versa. For this purpose, the electric motor 19 drives a cam wheel 16 via a transmission wheel 18. The cam wheel 16 has two cams 17 which are disposed on the broad side of the wheel and engage in the manner of a driving pin wheel in a cam-engagement recess 15 of the safety lever 5.

Likewise mounted about a housing-mounted bearing spindle is a release lever 3, on which an exterior handle acts. This release lever 3 has a drive pin 7 at one of its two ends. A wedge-shaped portion of the safety member 4 is located between the drive pin 7 and a mating drive shoulder 9 of a drive arm 10 of the catch 2.

The safety member 4 is articulated on an arm extension of the safety lever 5 such that it can be pivoted at the point of articulation 12. If the safety lever 5 is pivoted, then the wedge-shaped portion, which is formed by two drive shoulders 6, 8 oriented away from one another, moves between the mating drive shoulder 9 and the drive pin 7.

In addition, it is also possible for the release lever 14 to be actuated by a release linkage 20.

The lock functions as follows:

In the operating position illustrated in FIG. 1, the safety lever 5 is in its active position. This means that the wedge-shaped safety member 4 is located between the mating drive shoulder 9 of the catch 2 and drive pin 7 of the release lever 3. In this case, the drive shoulder 8 butts against the mating drive shoulder 9. The drive pin 7 of the non-actuated release lever 3 in this position is spaced apart to some extent from the drive shoulder 6 associated with it.

If, starting from the operating position illustrated in FIG. 1, the release lever 3 is actuated by being pivoted in the clockwise direction, then the drive pin 7 slides on the drive shoulder 6 of the safety member 4 which is associated with it, which results in the safety member 4 pivoting. In this case, the drive shoulder 8 slides along the mating drive shoulder 9, so that the catch 2 is pivoted into the release position according to FIG. 2.

In the case of the operating position illustrated in FIG. 3, the catch 2 and the release lever 3 are in the same position as in the operating position illustrated in FIG. 1. The catch 2 blocks the rotary latch 1. The release lever 3 has not been actuated.

This operating position is achieved in that, starting from the operating position illustrated in FIG. 1, the safety lever 5 is pivoted in the anti-clockwise direction, which is brought about by a cam 17 of the cam wheel 16 penetrating into the cam-engagement recess 15 and, in the manner of a driving pin wheel, causing the pivoting. Conversely, from the operating position illustrated in FIT. 3, the operating position illustrated in FIG. 1 can be achieved by virtue of the safety lever 5 being pivoted.

Actuation of the release lever 3 in the operating position illustrated in FIG. 3 results in the release lever being inoperative. This is illustrated in FIG. 4. By virtue of the safety member 4 being displaced back out of the spacing between drive pin 7 and mating shoulder 9, this displacement accompanying the pivoting of the safety lever 5 into the safety position, the drive pin 7 obtains clearance for movement. It is only in the fully pivoted position of the release lever 3 (see FIG. 4) that the drive pin 7 comes into contact with the drive shoulder 8 of the safety member 4 which is associated with it. It approaches the mating drive shoulder 9 of the catch 2 in this case.

The position illustrated in FIG. 4 corresponds to a lock which is located in the safety position and in the case of which the exterior handle has been actuated. If the motor 19 is actuated in this position, then the safety lever 5 is pivoted in the clockwise direction. The two drive shoulders 6, 8 of the safety member 4, these being located in a wedge-shaped manner in relation to one another, are forced between drive pin 7 and mating drive shoulder 9. With the release lever 3 retained in the actuated state, this results in the catch 2 yielding in the anti-clockwise direction, so that the rotary latch 1 is released, as is illustrated in FIG. 2.

In the case of the second exemplary embodiment, which is illustrated in FIG. 5, the safety lever 5 is driven by a helical drive rib 26. The helical drive rib 26 is seated on a shaft 24 which is driven by a motor 19. The circumferential length of the helical drive rib 26 is less than 360°, so that a gap remains between the two end surfaces 27, 28 of the helical drive rib 26. The safety lever 5 can penetrate through this gap when the shaft 24 has reached one of its two end positions. In the two end positions, either one end surface 27 or the other end surface 28 strikes against one of the two broad sides of the safety lever 5. The rotary movement of the shaft 24 stops as a result. In this end position, the safety lever 5 can be pivoted freely through the gap between the two end surfaces 27, 28.

Selection of the gradient of the helical drive rib 26 makes it possible to ensure uniform safety-lever pivoting.

The lock according to the third embodiment, illustrated in FIGS. 9-13, has a housing base plate 30. A cover plate 31, which is illustrated by chain-dotted lines, extends parallel to this base plate. The lock internals are located between this cover plate and the housing base plate 30. These comprise a rotary latch 32, which is arranged such that it can be pivoted about a rotary-latch spindle 33. By means of a fork mouth 34, the rotary latch 32, in the closed position of a motor-vehicle door, is able to intercept a mating locking part 35 of the bodywork. A blocking tooth (not designated specifically) of the rotary latch 32 interacts with a catch 36 when the door is closed. The single-armed catch 36 is mounted at its lower end by means of a housing-mounted articulation pin 37. A tension spring 38 extending between the catch 36 and the rotary latch 32 subjects the rotary latch 32 to loading in the opening direction and the catch 36 to loading in the blocking direction.

Above the catch 36, a release lever 39 extends between the base plate 30 and the cover plate 31. An exterior handle (not illustrated) of the motor-vehicle door (not illustrated) acts on this release lever. The release lever 39 is of angled configuration in plan view. It has a longer lever arm 39′ and a shorter lever arm 39″. The linkage leading to the exterior handle acts on the longer lever arm 39′. The shorter lever arm 39″, in the vicinity of the vertex between the two lever arms, has a cam 40 in the form of a hollow on the relevant flank of the lever arm 39″. The free end of the lever arm 39″ carries a pin 41, which engages in an arcuate slot 42 of the housing base plate 30. The free end of the lever arm 39″, moreover, extends level with the free end of the catch 36.

A safety member 43 interacts with the release lever 39, this safety member being a pivoting lever of obtuse-angled configuration. The pivoting lever or safety member 43 is mounted, at its angle vertex, about a closure-housing-mounted articulation pin 44. The shorter angle arm 43′ performs an abutment function in the active position of the safety member 43, see FIGS. 9 and 10. The longer angle arm 43″ is carrier for a guide pin 45 which, for its part, is guided in an arcuate slot 46 of the housing base plate 30, the arcuate slot being disposed concentrically in relation to the articulation pin 44.

This lock functions as follows:

If the safety member 43 assumes the active position illustrated in FIGS. 9 and 10, the lock is in the unlocked operating position. If the relevant vehicle door provided with the lock is to be opened, then the release lever 39 has to be pivoted by means of the corresponding exterior door handle. The pivot bearing S for this release lever is formed here by the vertex region of the release lever butting against the safety member 43, which forms an abutment. The release lever 39 rotates in the anti-clockwise direction about this pivot bearing, its pin 41 moving through the arcuate slot 42. This is accompanied by the lever arm 39″ acting upon the free end of the catch 36 by way of its free end and transferring this catch into a release position in relation to the rotary latch 32, see FIG. 10. The rotary latch 32 is thus no longer secured and the door can be opened, the mating locking part 35 leaving the fork mouth 34.

Starting from the operating position of the lock according to FIGS. 9 and 10, it is possible to bring about the operating position of the lock according to FIGS. 11 and 12. This takes place by the safety member 43, which can be displaced by a motor, being pivoted from its active position according to FIGS. 9 and 10 into the safety position according to FIGS. 11 and 12. The pin 45 is then located at the other end of the arcuate slot 46. In this case, the shorter lever arm 43′ of the safety member 43 is spaced apart from the cam 40 of the release lever 39, see FIG. 11. The pivot bearing S which is present according to FIGS. 9 and 10 is not now present. The pivot position S1, then, is formed by the abutment location between the free end of the lever arm 39″, and the facing peripheral edge of the catch 36. If the release lever 39 is then moved in the release direction about this pivot point S1, this does not, on account of the spaced-apart safety member 43, result in the catch being disengaged, see FIG. 12. The door cannot be opened.

It is possible, then, for the release lever 39 to be moved into its release position without the safety member previously having been moved by motor activation into its active position, which may take place, for example, by a key transponder pulse. If the safety member 43 is then pivoted by electric motor following this actuation of the release lever 39, then the shorter lever arm 43′ of the safety member 43 runs along the cam 40 of the release lever 39 and causes the pin 41 of the release lever 39 to be displaced in the direction of the catch 36 within the arcuate slot 42, in which case this catch is disengaged, see FIG. 13. The release lever 39 here executes a floating movement to a certain extent, to be precise within the limited setting predetermined by the arcuate slot guide. The position which corresponds to FIG. 10 is achieved by the safety member 43 having reached its active position. The locking member 35 is no longer captive and the motor-vehicle door can be opened.

In the fourth embodiment, according to FIGS. 14-18, the same components have the same designations. In contrast, the arcuate slot 42′ is now wider at the end which is directed towards the lever arm 39″. A link plate 48 which is approximately triangular in plan view acts on a coupling pin 47 at the angle vertex of the release lever 39. At the angle vertex located opposite the coupling pin 47, the link plate 48 is connected to the housing base plate 30 by means of an articulation stud 49. On one longitudinal flank, the link plate 48, which is triangular in plan view, forms a cam 50, on which a safety member 51 acts in the unlocked state of the lock. This safety member is a slide which, according to the exemplary embodiment depicted, is guided in a horizontal slot 52 of the housing base plate 30. The displacement of the safety member 51 preferably likewise takes place here by electric motor. It is possible here for the safety member 51 to be displaced from an active position according to 14 and 15 into a safety position according to 16 and 17. In the active position according to FIGS. 14 and 15, a flank 53 of the safety member 51 butts against the rectilinear cam 50.

If the lock is to be opened from the operating position according to FIG. 14, then the release lever 39 has to be displaced from the position according to FIG. 14 into the position according to FIG. 15. The pivot bearing S, then, is the coupling pin 47 between the release lever 39 and the link plate 48. The latter butts against the safety member 51. Thus by pivoting the release lever 39, the state in FIG. 15 is reached, the free end of the lever arm 39″ transferring the catch 36 into the release position in relation to the rotary latch 32.

If the locked, safety position of the lock is sought, see FIGS. 16 and 17, then this requires the actuating member 51 to be displaced into the safety position. The abutment is thus removed from the link plate 48. If the release lever 39 is then displaced in the anti-clockwise direction from the position according to FIG. 16 into the position according to FIG. 17, this is accompanied by the link plate 48 being pivoted in the clockwise direction about the articulation stud 49. At the same time, a pivoting and displacement movement of the free end 39″ of the lever arm 39 on the facing flank of the catch 36 also takes place, the pin 41 moving into the upper end region of the arcuate slot 42′. This means that the release lever 39 executes a floating movement, without transferring the catch 36 into the release position in the process.

With this version too, it is possible for the release lever 39 to be actuated before the safety member 51 has been displaced, see FIG. 18. If the safety member 41 is then displaced with a delay, this being caused by key transponder actuation, the safety member 51 moves in the direction of the link plate 48, the flank 53 acting upon the cam 50 of the link plate 48 and forcing displacement of the release lever in the process, the lever arm 39″ of the latter acting upon the catch 36 and pivoting this catch into the release position in relation to the rotary latch 32, see FIG. 18.

The fifth embodiment, illustrated in FIGS. 19 to 28, is similar to the third embodiment. The same components are provided with the same designations.

In this case, the displacement plane of the safety member 54 is located perpendicularly to the displacement plane of the release lever 39. For this purpose, the safety member 54, which is configured as a safety slide, is guided in the cover plate 31 of the lock. The safety slide 54 may be displaced, for example, electromagnetically. If the safety slide 54 is moved into its active position according to FIGS. 19 and 20, then the free end of the safety slide 54 engages in an arresting opening 55 of the housing base plate 30. The end 54′ of the safety slide 54, this end interacting with the release lever 39, is of flat configuration. It is guided in a non-rotatable manner. On its narrow edge which is directed towards the release lever 39, the free end 54′ is provided with a drive slope 54″. In the region of its angle vertex, the release lever 39 forms a protrusion 56 which is oriented in the direction of the cover plate 31. This protrusion forms a cam 57 which interacts with the drive slope 56″. In order not to impair the free movement capability of the release lever 39, a recess 58 is provided for the protrusion 56 within the cover plate 31.

FIGS. 19 and 20 concern the operating position in which the safety member 54, which is configured as a safety slide, assumes its active position. This means that the free end 54′ has penetrated into the arresting opening 55 of the base plate 30. The safety member 54 thus forms an abutment for the release lever 39. If the lock is then to be unlocked, the release lever 39 has to be pivoted into the position according to FIG. 21. The pivoting bearing S here is the abutment location between the safety member 54 and release lever 39. The release lever 39 rotates in the anti-clockwise direction about this pivot bearing S, the lever arm 39″ acting upon the facing flank of the free end of the catch 32 and disengaging the latter into a release position. The rotary latch 32 can thus be rotated freely and releases the mating locking part 35 when the relevant motor-vehicle door is opened.

FIGS. 23 and 24 show the operating position of the lock in which the safety member 54 has been displaced into the safety position. This means that the pivot bearing S now has no function. If, starting from FIG. 23, the release lever 39 is actuated, then the pivot point S1 between the release lever 39 and catch 36 comes into operation. Accordingly, the catch 36 remains in its blocking position. The motor-vehicle door thus cannot be opened.

If the release lever has been actuated before the safety member 54 is displaced, this results in the position according to FIG. 27. When the safety member 54 is subsequently moved into the active position, the drive slope 54″ of the safety slide 54 then engages against the cam 57 of the release lever 39 and displaces the latter, the pin 41 running through the arcuate slot 42 and the lever arm 39″ forcing the catch 36 to be disengaged, see FIGS. 27 and 28. Displacement of the safety member 54 results in the position which corresponds to FIGS. 21 and 22.

According to the sixth embodiment, illustrated in FIGS. 29-33, the lock housing (not illustrated) carries the rotary latch 59, with which the catch 60 is associated. The lock housing, furthermore, is carrier for an articulation pin 61 for the catch 60 and for a release lever 62. At its end which is directed towards the catch 60, this release lever is provided with a longitudinal slot 63, through which the articulation pin 61 engages. In the unlocked position according to FIG. 29, the upper end of the longitudinal slot 63 butts against the articulation pin 61. A pivot bearing S is formed there. In the vicinity of its longitudinal slot 63, the release lever 62 forms a drive shoulder 64 which runs approximately transversely to the direction of the longitudinal slot. A mating shoulder 65 of the catch 60 is located directly opposite the drive shoulder.

At the other end, the release lever 62 forms a protrusion 66. In the protrusion, there is an arcuate slot 67, into which the coupling pin 68 of a piston member 69, which constitutes the safety member, penetrates. This piston member is the push rod of a linear drive 70. The latter may be configured as an electromagnet, the piston member 69 being the armature. The linear drive 70, for its part, is secured on the lock housing (not illustrated).

If the lock is to be opened, then the lever-like release member 62 has to be pivoted in the clockwise direction out of the position according to FIG. 29 into the position according to FIG. 30. In this case, the drive shoulder 64 of the release lever 62 acts upon the mating shoulder 65 of the catch 60 and moves the latter into the release position in relation to the rotary latch 59. The motor-vehicle door can thus be opened. If the safety position of the lock is desired, then the linear drive 70 has to be initiated. The push-rod-like piston member 69 in this case is drawn back, with the release lever 62 being brought in the process from the position according to FIG. 29 into the position according to FIG. 31. The drive shoulder 64 thus moves away from the mating shoulder 65. If the release lever 62 is then pivoted into the release position according to FIG. 32, this results in the release lever 62 being inoperative. The catch 60 thus remains in blocking engagement. If, for the purpose of opening the lock, the release lever 62 is actuated before the safety member or the piston member 69 is displaced, this initially results in the release lever 62 being inoperative. However, if the piston member 69, controlled by the linear drive 70, then moves forward, the release lever 62 is displaced longitudinally, the drive shoulder 64 of the release lever pivoting the catch 60, via the mating shoulder 65, into the release position according to FIG. 33.

The same components of the seventh embodiment, illustrated in FIGS. 34 to 38, have the same designations as the sixth embodiment. In contrast, the piston member, which constitutes the safety member 69, in this case is seated on the release lever 62′. This means that the linear drive 70 is secured in a stationary manner on the release lever 62′ and causes the piston member 69 to be displaced. The release lever 62′ is mounted on the articulation pin 61, which also carries the catch 60. Rather than being displaced longitudinally, the release lever 62′ is subject exclusively to rotary displacement. The catch 60 forms the mating shoulder 65 opposite the drive shoulder 64 of the piston member 69 or safety member.

In the unlocked position according to FIG. 34, the piston member 69 is in the advanced position. In this coupling position, the drive shoulder 64 of the piston member is located in the vicinity of the mating shoulder 65. If the release lever 62′ is then actuated in the clockwise direction according to FIG. 35, the piston member 69 acts upon the mating shoulder 65 of the catch 60 and moves the latter into a release position in relation to the rotary latch 59. The lock can thus be opened.

In order to bring about the safety position, the piston member 69 is drawn back out of its coupling position by the linear drive 70, this then resulting in the position according to FIG. 36. Pivoting displacement of the release lever 62′, accordingly, only causes the latter to be inoperative, without moving the catch out of its blocking position in the process. If the release lever 62′ has been moved into its release position, and only then is the piston member 69 or safety member moved, the piston member 69 here acts upon the mating shoulder 65 of the catch 60 in conjunction with the catch being rotated into the release position, as a result of which the lock is opened, see FIG. 38.

In the case of the eighth embodiment, illustrated in perspective in FIGS. 39 and 40, the rotary latch is designated 71. Associated with it is the catch 72, which is likewise mounted on the lock housing (not illustrated). This catch is connected in a rotationally fixed manner to a catch lever 73. The latter forms, by way of a sloping flank, a cam 74 for interacting with an arm portion 75 of an angularly configured release lever 76. The other arm portion 77 serves for the engagement of the exterior handle (not illustrated). The pivot bearing 78 is located at the angle vertex of the release lever 76. This pivot bearing is associated with safety member 79. The latter is mounted on the lock housing in a manner which is not illustrated. In detail, such an arrangement is realized that the pivot bearing 78 is seated on a lever arm 80 of the safety member 79, which can be driven by an electric motor. By means of the electric motor drive, the safety member 79 can be moved from the position according to FIG. 39 into the position according to FIG. 40 and back.

According to FIG. 39, the lock is in the unlocked position. The safety member 79 is then pivoted such that the arm portion. 75 can assume the task of displacing the catch lever 73. This is the case when the release lever 76 is subjected to a force which causes it be loaded in the anti-clockwise direction. The arm portion 75 acts upon the catch lever 73, and thus also the catch 72 which, for its part, releases the rotary latch 71.

If the safety position according to FIG. 40 is sought, then the safety member can be pivoted in the clockwise direction, for example, by remote-actuation by means of the key, so that the position according to FIG. 40 is established. At the same time, the release lever 76 is also carried along, the arm portion 75 of the latter then being inoperative upon release lever actuation, that is to say moving past the catch lever 73 and the cam 74 without having any effect. If the open position is to be produced, although the release lever 76 is moved into the release position, opening is nevertheless possible by way of the safety member 79. In the release position 76, the arm portion 75 extends in the region of the cam 74, S0 that, when the safety member 79 is pivoted in the anti-clockwise direction, the arm portion 75 comes into contact with the cam 74 and, in the process, causes the catch lever 73 and the catch 72 to be pivoted into the release position.

The ninth embodiment of the lock, illustrated in FIG. 41, largely corresponds in terms of its construction to the seventh embodiment, illustrated in FIGS. 34-38. The same components are provided with the same designations. The rotary latch 59 interacts with the catch 60 which, for its part, is disposed in a pivotable manner on the articulation pin 61 of the lock housing. The release lever 62′ is seated in a pivotable manner on the articulation pin 61, a remote-actuation means 81 acting on the release lever. The catch 60 is the carrier for a mating shoulder 65, which is configured in the form of a pin. This mating shoulder interacts with the piston member 69 of the linear drive 70, which is disposed on the release lever 62′. In the safety position according to FIG. 41, the piston member 69 is spaced apart from the mating shoulder 65. Displacement of the release lever 62′ then does not result in the catch 60 being disengaged. Displacement of the piston member 69 in front of the mating shoulder 65 by means of the actuating member 70 results in the active position. Pivoting displacement of the release lever 62′ then leads to a release position of the catch 60 in relation to the rotary latch 59.

In terms of action, the tenth embodiment, according to FIGS. 42-47, is based on the eight embodiment, illustrated in FIGS. 39 and 40. The rotary latch 71 interacts in a known manner with the catch 72. Integrally formed on the latter is a catch lever 73, which forms a cam 74 on the underside. The catch 72 then forms a drive portion 82 for interacting with a release lever 83. The latter is a two-armed angle lever, the short, load arm 83′ of which engages beneath the portion 82 of the catch 72, and the long, force arm 83″ of which is forced in the clockwise direction upon triggering actuation at the free-end. A pivot bearing 84 engages through the angle vertex of the angle lever 83, this pivot bearing being located at the free end of a safety member 85. The pivot bearing 84, which is configured in the form of a pin, is guided in a link guide 86 of the lock housing. The link guide 86 is an arcuate slot which runs concentrically in relation to the articulation spindle 87 of the safety member 85, which is configured as a pivoting lever. The ends of the link guide 86 form two fixed stops 86′, 86″ for the safety member 85.

As FIG. 47 illustrates, the pivoting lever or the safety member 85 can be fixed in its respective pivoting end position by means of an over-dead-center spring 88. For this purpose, the over-dead-center spring 88 acts on a slide 89 which is guided in a longitudinal slot within the pivoting lever 85 and forms a link pin 90. The latter is guided in an arcuate slot 91 of the lock housing. Once the dead-center position has been passed, the link pin 90 tries to move into the corresponding end region of the arcuate slot 91.

In the non-actuated, unlocked position which is illustrated in FIG. 42, the pivot bearing 84 assumes the active position. This means that the safety member 85 has been pivoted correspondingly. If the release lever 83 is then forced in the arrow direction into the position according to FIG. 43, the load arm 83′ engages against the portion 82 and raises the catch 72 into the release position in relation to the rotary latch 71. The lock can thus be opened. As FIGS. 42 and 43 illustrate, the force arm 83″ and the pivoting lever 85 enclose an obtuse angle. The latter is oriented in the direction of the right-hand side according to FIGS. 42 and 43. In FIG. 43, the obtuse angle has become smaller than in FIG. 42. This ensures that, when the release lever 83 is actuated, the pivoting lever 85 is forced against the left-hand fixed stop 86′ of the link guide 86.

In order to bring about the safety position according to FIGS. 44 and 45, the safety member 85 or the pivoting lever has to be pivoted in the clockwise direction toward its other fixed stop. In this case, the pivoting lever 85 passes over the dead-center line and is retained in the other end position by means of the over-dead-center spring 88. If the release lever 83 is then displaced from the position according to FIG. 44 into the position according to FIG. 45, the load arm 83′ is inoperative here. It does not act upon the catch 72, S0 that the latter remains in its engaged position in relation to the rotary latch 71. It can be gathered from FIG. 44 that, in the safety position, the obtuse angle enclosed by the pivoting lever 85 and force arm 83″ of the non-actuated release lever 83 opens in the opposite direction to that in the active position (see also FIG. 42 in this respect).

If the release lever 83 has already been actuated without displacement of the safety member 85 having taken place, then it is nevertheless possible upon displacement of the safety member 85, with the release lever 83 held, for the lock to be opened, the load arm 83′ acting upon the cam 74 of the catch 72 and raising the latter into the release position (see FIG. 46).

In the eleventh embodiment, according to FIGS. 48-51, the catch 93 is associated with the rotary latch 92. This catch carries a drive pin 93′ for interacting with an angled transmission lever 94 mounted on the lock housing 106. One lever arm 94′ of the transmission lever interacts with the drive pin 93′, while the other lever arm 94″ can be acted upon by the pin 95′ of a release lever 95. At its free end, the lever arm 94″ forms a cam 96 for interacting with the pin 95′.

In specific terms, the release lever 95 is of angled configuration. At the angle vertex, the pivot bearing 97 extends between the release lever 95 and the lever-like safety member 98. The latter is mounted about an articulation pin 99 which is fixed to the housing. In the region between the pivot bearing 97 and the articulation pin 99, the coupling pin 100 of a toggle lever 101 acts on the safety member 98. This toggle lever contains the two links 102 and 103, which are connected to one another via a toggle joint 104. The link 103 is articulated, at the end, on the closure housing 106 by means of a pin 105.

In the active position, which is illustrated in FIGS. 48 and 49, the toggle lever 101 assumes a secured over-dead-center position. The pivot bearing 97 here has moved the release lever 95 such that, when the latter is forced in the anti-clockwise direction into the position according to FIG. 49, the pin 95′ subjects the lever arm 94″ of the transmission lever 94 to loading and pivots it in the clockwise direction. In this case, the catch 93 is moved into the release position in relation to the rotary latch 92 via the lever arm 94′ and the drive pin 93′. The lock can thus be opened.

According to the illustration in FIG. 50, the toggle lever 101 has passed into the other over-dead-center position, with the safety member 98 being pivoted in the anti-clockwise direction at the same time. This takes place, as in the case of the preceding embodiments, by remote control. In this case, the pivot bearing 97 is carried along and, accordingly, the release lever 95 is moved into the position in which, when it is forced in the anti-clockwise direction into the position according to FIG. 51, the pin 95′ is inoperative and, accordingly, the transmission lever 94 is not subjected to loading and the catch 93 thus remains in its engaged position in relation to the rotary latch 92 (see FIG. 51). From this position, however, it is possible for the lock to be opened via the safety member 98, to be precise in that the toggle lever 101 passes into the over-dead-center position according to FIG. 49. This is accompanied by the pin 95′ of the release lever 95 acting upon the cam 46 of the transmission lever 94, as a result of which the catch 93 is disengaged into the release position.

All features disclosed are (in themselves) pertinent to the invention. The disclosure content of the associated/attached priority documents (copy of the prior application) is hereby also included in full in the disclosure of the application, also for the purpose of incorporating features of these documents in claims of the present application.

1. Lock having a latch (1) which can be displaced between an open position and a closed position and is retained in the closed position by a catch (2), it being possible for the catch (2), by virtue of a release means (3) being pivoted about a pivot bearing, to be moved from a blocking position into a release position which allows the latch to be displaced into its open position, the release means (3) acting on the catch (2), and having a safety member (4) which can assume an active position, which allows displacement of the catch (2) by release means actuation, and a safety position, which allows the release means to be inoperative upon actuation, the changeover between the active position and the safety position of the safety member (4) taking place, in particular, by an electric motor such that with the release means (3) moved into the release position, upon changeover from the safety position into the active position, the catch (2) is moved into its release position, characterized in that a safety lever (5) which carries the safety member (4) is driven for pivoting action by a helical drive rib (26) which penetrates into an engagement opening (15) and is disposed on a shaft (24).

2. Lock according to claim 1 or in particular according thereto, characterized in that the drive rib (2) forms end surfaces (27, 28) which strike against the broad surface of the safety lever (5).

3. Lock according to one or more of the preceding claims or in particular according thereto, characterized in that the engagement opening (15), in the two striking positions, is free.

4. Lock according to one or more of the preceding claims or in particular according thereto, characterized in that the circumferential length of the drive rib (26) is less than 360°.

5. Pivoting drive in particular for a lock according to one or more of the preceding claims, having a rotatable drive part and a pivoting part which forms an engagement opening (15) for a drive element of the drive part and can be moved back and forth between two pivoting positions by virtue of the drive part being rotated, and is uncoupled from the drive part in the end positions of the latter, characterized in that the drive part forms a helical drive rib (26), the end surfaces (27, 28) of which are spaced apart from one another by a circumferential distance which is at least equal to the thickness of the pivoting part.

6. Lock having a latch (32) which can be displaced between an open position and a closed position and is retained in the closed position by a catch (36), it being possible for the catch (36), by virtue of a release means (39) being pivoted about a pivot bearing (S), to be moved from a blocking position into a release position which allows the latch (32) to be displaced into its open position, the release means (39) acting on the catch (36), and having a safety member (43, 51, 54) which can assume an active position, which allows displacement of the catch (36) by release means actuation, and a safety position, which allows the release means to be inoperative upon actuation, the changeover between the active position and the safety position of the safety member (43, 51, 54) taking place, in particular, by an electric motor such that with the release means (39) moved into the release position, upon changeover from the safety position into the active position, the catch (36) is moved into its release position, characterized in that the pivot bearing (S) of the release means (39) has no function in the safety position.

7. Lock according to claim 6 or in particular according thereto, characterized in that the release means (39) is made to float by changeover into the safety position.

8. Lock according to one or more of the preceding claims or in particular according thereto, characterized in that the safety member (43, 51, 54) performs an abutment function, which is done away with in the safety position.

9. Lock according to one or more of the preceding claims or in particular according thereto, characterized in that the release means (39) has a cam (40, 50, 57) on which, with the release means (39) actuated, the safety member (43, 51, 54) acts as it is displaced into the active position and there, sliding along into the abutment position, transfers the catch (36) into the open position.

10. Lock according to one or more of the preceding claims or in particular according thereto, characterized in that the arm (39″) of the release means (39), this arm acting on the catch (36), or the pivot bearing of the release means is guided in an arcuate manner.

11. Lock according to one or more of the preceding claims or in particular according thereto, characterized in that the arcuate guide is formed by a slot/pin guide (41, 42, 42′) or a bearing link plate (48).

12. Lock according to one or more of the preceding claims or in particular according thereto, characterized in that the safety member (43) is a pivoting lever.

13. Lock according to one or more of the preceding claims or in particular according thereto, characterized in that the safety member (51) acts on a bearing link plate (48) of the release means (39), the cam (50) being assigned to the bearing link plate.

14. Lock according to one or more of the preceding claims or in particular according thereto, characterized in that the displacement plane of the safety member (54) is located perpendicularly to the displacement plane of the release means (39).

15. Lock according to one or more of the preceding claims or in particular according thereto, characterized in that the safety slide (54), which can be displaced in the axial direction of the pivot bearing (S), moves into an arresting opening (55) of a housing base plate (30).

16. Lock having a latch (59) which can be displaced between an open position and a closed position and is retained in the closed position by a catch (60), it being possible for the catch (60), by virtue of a release means (62, 62′) being pivoted about a pivot bearing, to be moved from a blocking position into a release position which allows the latch (59) to be displaced into its open position, the release means (62, 62′) acting on the catch (60), and having a safety member (69) which can assume an active position, which allows displacement of the catch (60) by release means actuation, and a safety position, which allows the release means to be inoperative upon actuation, the changeover between the active position and the safety position of the safety member (69) taking place, in particular, by an electric motor such that with the release means (62, 62′) moved into the release position, upon changeover from the safety position into the active position, the catch (60) is moved into its release position, characterized in that the safety member (69) is a piston member (69) a drive shoulder (64) of the release means (62, 62′) can be displaced in the active direction into a coupling position in relation to a mating shoulder (65) of the catch (60).

17. Lock according to claim 16 or in particular according thereto, characterized in that the piston member (69) is the push rod of a linear drive (70).

18. Lock according to one or more of the preceding claims or in particular according thereto, characterized in that the piston member (69) is seated on the release means (62′).

19. Lock according to one or more of the preceding claims or in particular according thereto, characterized in that the piston member (69) displaces the release means (62) longitudinally.

20. Lock having a rotary latch (71) which can be displaced between an open position and a closed position and, in the closed position, can be moved by a catch (72), by virtue of a release means (76) being pivoted about a pivot bearing (78), from a blocking position into a release position which allows the latch (59) to be displaced into its open position, the release means (76) acting on the catch (72), and having a safety member (79) which can assume an active position, which allows displacement of the catch (72) by release means actuation, and a safety position, which allows the release means to be inoperative upon actuation, the changeover between the active position and the safety position of the safety member (79) taking place, in particular, by an electric motor such that with the release means (76) moved into the release position, upon changeover from the safety position into the active position, the catch (72) is moved into its release position, characterized in that the pivot bearing (78) of the release means (76) is associated with the safety member (79) and, by virtue of the displacement thereof, the release means (76) can be moved from the inoperative position into the active position.

21. Lock according to claim 20 or in particular according thereto, characterized in that the pivot bearing (78) is seated on a lever arm (80) of the safety member (79).

22. Lock according to one or more of the preceding claims or in particular according thereto, characterized in that the release means (76), displaced in the release position by the safety member (79), pivots the catch (72) with sloping-flank drive.

23. Lock having a rotary latch (71, 92) which can be displaced between an open position and a closed position and, in the closed position, can be moved by a catch (72, 93), by virtue of a release means (83, 95) being pivoted about a pivot bearing (84, 97), from a blocking position into a release position which allows the latch (71, 92) to be displaced into its open position, the release means (83, 95) acting on the catch (72, 93), and having a safety member (85, 98) which can assume an active position, which allows displacement of the catch (72, 93) by release means actuation, and a safety position, which allows the release means to be inoperative upon actuation, the changeover between the active position and the safety position of the safety member (85, 98) taking place, in particular, by an electric motor such that with the release means (83, 95) moved into the release position, upon changeover from the safety position into the active position, the catch (72, 93) is moved into its release position, characterized in that the pivot bearing (84, 97) can be displaced back and forth between active position and safety position.

24. Lock according to claim 23 or in particular according thereto, characterized in that the safety member (85, 98) is a carrier for the pivot bearing (84, 97) of the release means (83, 95).

25. Lock according to one or more of the preceding claims or in particular according thereto, characterized in that the pivot bearing (84) is guided in a link guide (86) of the lock housing.

26. Lock according to one or more of the preceding claims or in particular according thereto, characterized in that the safety member (85) is a pivoting body, in particular a pivoting lever, which can be displaced between two fixed stops (86′, 86″).

27. Lock according to one or more of the preceding claims or in particular according thereto, characterized in that the release means (83), which is articulated at the free end of the pivoting lever (85), is a two-armed angle lever, the short, load arm (83′) of which engages beneath the catch (72) and the long, force arm (83″) of which is directionally activated for the purpose of releasing the catch (72) such that the pivoting lever (85) is forced against the fixed stop (86′ or 86″) associated with the respective position.

28. Lock according to one or more of the preceding claims or in particular according thereto, characterized in that, in the safety position, the obtuse angle enclosed by the pivoting lever (85) and by the force arm (83″) of the non-actuated release means (83) opens in the opposite direction to that in the active position.

29. Lock according to one or more of the preceding claims or in particular according thereto, characterized in that the pivoting lever (85) is retained in its respective pivoting end position by means of an over-dead-center spring (88).

30. Lock according to one or more of the preceding claims or in particular according thereto, characterized in that the safety member (98) is connected to the housing by a toggle lever (101), which toggle lever (101) assumes a safety over-dead-center position in the active position.
